(19) United States
(12) Patent Application Publication
(10) Pub. No.: US 2025/0202546 A1
(43) Pub. Date: Jun. 19, 2025

(54) CSI REPORTING FOR 5G NR SYSTEMS

(71) Applicant: Fraunhofer-Gesellschaft zur Förderung der angewandten Forschung e.V., MÜNCHEN (DE)

(72) Inventors: Marcus Grossmann, Erlangen (DE); Markus Landmann, Erlangen (DE); Venkatesh Ramireddy, Erlangen (DE); Sutharshun Varatharaajan, Erlangen (DE)

(73) Assignee: Fraunhofer-Gesellschaft zur Förderung der angewandten Forschung e.V., MÜNCHEN (DE)

(21) Appl. No.: 18/847,669

(22) PCT Filed: Mar. 15, 2023
(86) PCT No.: PCT/EP2023/056652

§ 371 Date: Sep. 16, 2024

(30) Foreign Application Priority Data
Mar. 15, 2022 (EP) 22162122.0
Nov. 4, 2022 (EP) 22207175.5

(51) Int. Cl. H04B 7/0417

(52) U.S. Cl. CPC H04B 7/0417

(57) ABSTRACT

Methods and apparatuses for channel state information (CSI) reporting in a wireless communications network are described. One method performed by a wireless device includes receiving the CSI report configuration and a higher layer configuration indicating a subset of spatial-domain components from a set of spatial-domain components and a maximum average amplitude value or power for restricting an average amplitude or power of the combination coefficients associated with the spatial-domain component in the subset of spatial-domain components. The method may also include determining a spatial-domain component from a set spatial-domain components, a time-domain components from a set of time-domain components, and a frequency-domain components from a set of frequency-domain components, and generating and transmitting or the CSI report which may include an indication of the determined spatial-, frequency- and time-domain components, and combination coefficients of the precoder vector or matrix.

### TECHNICAL FIELD

The present disclosure relates to the field of wireless communications, and in particular to methods and apparatuses for Channel State Information (CSI) feedback reporting for a codebook-based precoding in a wireless communications network such as advanced 5G networks.

### BACKGROUND

The fifth generation (5G) mobile communications system also known as new radio (NR) provides a higher level of performance than the previous generations of mobile communications system. 5G mobile communications has been driven by the need to provide ubiquitous connectivity for applications as diverse automotive communication, remote control with feedback, video downloads, as well as data applications for Internet-of-Things (IoT) devices, machine type communication (MTC) devices, etc. 5G wireless technology brings several main benefits, such as faster speed, shorter delays, and increased connectivity. The third-generation partnership project (3GPP) provides the complete system specification for the 5G network architecture, which includes at least a radio access network (RAN), core transport networks (CN) and service capabilities.

FIG. 1 illustrates a simplified schematic view of an example of a wireless communications network 100 including a core network (CN) 110 and a radio access network (RAN) 120. The RAN 120 is shown including a plurality of network nodes or radio base stations, which in 5G are called gNBs. Three radio base stations are depicted gNB1, gNB2 and gNB3. Each gNB serves an area called a coverage area or a cell. FIG. 1 illustrates 3 cells 121, 122 and 123, each served by its own gNB, gNB1, gNB2 and gNB3, respectively. It should be mentioned that the network 100 may include any number of cells and gNBs. The radio base stations, or network nodes serve users within a cell. In 4G or LTE, a radio base station is called an eNB, in 3G or UMTS, a radio base station is called an eNodeB, and BS in other radio access technologies. A user or a user equipment (UE) may be a wireless or a mobile terminal device or a stationary communication device. A mobile terminal device or a UE may also be an IoT device, an MTC device, etc. IoT devices may include wireless sensors, software, actuators, and computer devices. They can be imbedded into mobile devices, motor vehicle, industrial equipment, environmental sensors, medical devices, aerial vehicles and more, as well as network connectivity that enables these devices to collect and exchange data across an existing network infrastructure.

Referring back to FIG. 1, each cell is shown including UEs and IoT devices. gNB1 in cell 121 serves UE1 121A, UE2 121B and IoT device 121C. Similarly, gNB2 in cell 121 serves UE3 122A, UE4 122B and IoT device 122C, and gNB3 in cell 123 serves UE5 123A, UE6 123B and IoT device 123C. The network 100 may include any number of UEs and IoT devices or any other types of devices. The devices communicate with the serving gNB(s) in the uplink and the gNB(s) communicate with the devices in the downlink. The respective base station gNB1 to gNB3 may be connected to the CN 120, e.g., via the S1 interface, via respective backhaul links 111, 121D, 122D, 123D, which are schematically depicted in FIG. 1 by the arrows pointing to “core”. The core network 120 may be connected to one or more external networks, such as the Internet. The gNBs may be connected to each other via the S1 interface or the X2 interface or the XN interface in 5G, via respective interface links 121E, 122E and 123E, which is depicted in the figure by the arrows pointing to gNBs.

For data transmission, a physical resource grid may be used. The physical resource grid may comprise a set of resource elements (REs) to which various physical channels and physical signals are mapped. For example, the physical channels may include the physical downlink, uplink and/or sidelink (SL) shared channels (PDSCH, PUSCH, PSSCH) carrying user specific data, also referred to as downlink, uplink or sidelink payload data, the physical broadcast channel (PBCH) carrying for example a master information block (MIB) and a system information block (SIB), the physical downlink, uplink and/or sidelink control channels (PDCCH, PUCCH, PSCCH) carrying for example the downlink control information (DCI), the uplink control information (UCI) or the sidelink control information (SCI). For the uplink, the physical channels may further include the physical random-access channel (PRACH or RACH) used by UEs for accessing the network once a UE is synchronized and obtains the MIB and SIB. The physical signals may comprise reference signals (RS), synchronization signals (SSs) and the like. The resource grid may comprise a frame or radio frame having a certain duration, like 10 milliseconds, in the time domain and having a given bandwidth in the frequency domain. The radio frame may have a certain number of subframes of a predefined length, e.g., 2 subframes with a length of 1 millisecond. Each subframe may include two slots of a number of OFDM symbols depending on the cyclic prefix (CP) length. IN 5G, each slot consists of 14 OFDM symbols or 12 OFDM symbols based on normal CP and extended CP respectively. A frame may also consist of a smaller number of OFDM symbols, e.g., when utilizing shortened transmission time intervals (TTIs) or a mini-slot/non-slot-based frame structure comprising just a few OFDM symbols. Slot aggregation is supported in 5G NR and hence data transmission can be scheduled to span one or multiple slots. Slot format indication informs a UE whether an OFDM symbol is downlink, uplink or flexible.

The wireless communication network system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR (New Radio) standard.

The wireless communications network system depicted in FIG. 1 may be a heterogeneous network having two distinct overlaid networks, a network of macro cells with each macro cell including a macro base station, like base station gNB1 to gNB3, and a network of small cell base stations (not shown in FIG. 1), like femto- or pico-base stations. In addition to the above described wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-advanced pro standard or the 5G or NR, standard.

In the wireless communications network system such as the one depicted schematically in FIG. 1, multi-antenna techniques may be used, e.g., in accordance with LTE, NR or any other communication system, to improve user data rates, link reliability, cell coverage and network capacity. To support multi-stream or multi-layer transmissions, linear precoding is used in the physical layer of the communication system. Linear precoding is performed by a precoder matrix which maps layers of data to antenna ports. The precoding may be seen as a generalization of beamforming, which is a technique to spatially direct or focus a data transmission towards an intended receiver. The precoder matrix to be used at the gNB to map the data to the transmit antenna ports is decided using channel state information, CSI.

In the wireless communications network system as described above, such as LTE or New Radio (5G), downlink signals convey data signals, control signals containing downlink, DL, control information (DCI), and a number of reference signals or symbols (RS) used for different purposes. A gNodeB (or gNB or base station) transmits data and downlink control information (DCI) through the so-called physical downlink shared channel (PDSCH) and physical downlink control channel (PDCCH) or enhanced PDCCH (ePDCCH), respectively. Moreover, the downlink signal(s) of the gNB may contain one or multiple types of reference signals (RSs) including a common RS (CRS) in LTE, a channel state information RS (CSI-RS), a demodulation RS (DM-RS), and a phase tracking RS (PT-RS). The CRS is transmitted over a DL system bandwidth part and used at the user equipment (UE) to obtain a channel estimate to demodulate the data or control information. The CSI-RS is transmitted with a reduced density in the time and frequency domain compared to CRS and used at the UE for channel estimation or for channel state information (CSI) acquisition. The DM-RS is transmitted only in a bandwidth part of the respective PDSCH and used by the UE for data demodulation. For signal precoding at the gNB, several CSI-RS reporting mechanisms are used such as non-precoded CSI-RS and beamformed CSI-RS reporting. For a non-precoded CSI-RS, a one-to-one mapping between a CSI-RS port and a transceiver unit, TXRU, of the antenna array at the gNB is utilized. Therefore, non-precoded CSI-RS provides a cell-wide coverage where the different CSI-RS ports have the same beam direction and beam width. For beamformed/precoded UE-specific or non-UE-specific CSI-RS, a beamforming operation is applied over a single antenna port or over multiple antenna ports to have several narrow beams with high gain in different directions and, therefore, no cell-wide coverage.

In a wireless communications network system employing time division duplexing, TDD, due to channel reciprocity, the CSI is available at the base station (gNB). However, when employing frequency division duplexing, FDD, due to the absence of channel reciprocity, the channel is estimated at the UE and the estimate is fed back to the gNB. FIG. 2 shows a block-based model of a Multiple Input Multiple Output (MIMO) DL transmission using codebook-based-precoding in accordance with LTE release 8. FIG. 2 shows schematically the base station 200, gNB, the user equipment, UE, 202 and the channel 204, like a radio channel for a wireless data communication between the base station 200 and the user equipment 202. The base station includes an antenna array ANT_{T} having a plurality of antennas or antenna elements, and a precoder 206 receiving a data vector 208 and a precoder matrix F from a codebook 210. The channel 204 may be described by the channel tensor/matrix 212. The user equipment 202 receives the data vector 214 via an antenna or an antenna array ANT_{R} having a plurality of antennas or antenna elements. A feedback channel 216 between the user equipment 202 and the base station 200 is provided for transmitting feedback information. The previous releases of 3GPP up to Release 15 support the use of several downlink reference symbols (such as CSI-RS) for CSI estimation at the UE.

In FDD systems (up to Rel. 15), the estimated channel at the UE is reported to the gNB implicitly where the CSI report transmitted by the UE over the feedback channel includes the rank index (RI), the precoding matrix index (PMI) and the channel quality index (CQI) (and the CRI from Rel. 13) allowing, at the gNB, to decide the precoding matrix, and the modulation order and coding scheme (MCS) of the symbols to be transmitted. The PMI and the RI are used to determine the precoding matrix from a predefined set of matrices Ω also referred to as codebook. The codebook, e.g., in accordance with LTE, may be a look-up table with matrices in each entry of the table, and the PMI and RI from the UE decide from which row and column of the table the precoder matrix to be used is obtained. The precoders and codebooks are designed up to Rel. 15 for gNBs equipped with one-dimensional Uniform Linear Arrays (ULAs) having N₁ dual-polarized antennas (in total Nₜ=2N₁ antennas), or with two-dimensional Uniform Planar Arrays (UPAs) having dual-polarized antennas at N₁N₂ positions (in total Nₜ=2N₁N₂ antennas). The ULA allows controlling the radio wave in the horizontal (azimuth) direction only, so that azimuth-only beamforming at the gNB is possible, whereas the UPA supports transmit beamforming on both vertical (elevation) and horizontal (azimuth) directions, which is also referred to as full-dimension (FD) MIMO. The codebook, e.g., in the case of massive antenna arrays such as FD-MIMO, may be a set of beamforming weights that forms spatially separated electromagnetic transmit/receive beams using the array response vectors of the array. The beamforming weights (also referred to as the array steering vectors) of the array are amplitude gains and phase adjustments that are applied to the signal fed to the antennas (or the signal received from the antennas) to transmit (or obtain) a radiation towards (or from) a particular direction. The components of the precoder matrix are obtained from the codebook, and the PMI and the RI are used to read the codebook and obtain the precoder. The array steering vectors may be described by the columns of a 2-Dimensional Discrete Fourier Transform (DFT) matrix when ULAs or UPAs are used for signal transmission.

The precoder matrices used in the Type-I, Type-I multi-panel and Type-II CSI reporting schemes in 3GPP New Radio Rel. 15 are defined in the frequency-domain and have a dual-stage structure (i.e., two components codebook): F(s)=F₁F₂(s), s=0 . . . , S−1, where S denotes the number of subbands. The first component or the so-called first stage precoder, F₁, is used to select a number of beam vectors from a Discrete Fourier Transform-based (DFT-based) matrix, which is also called the spatial codebook. Moreover, the first stage precoder, F₁, corresponds to a wide-band matrix, independent of the subband index s, and contains L spatial beamforming vectors (the so-called spatial beams) bₗ∈ [symbol] ^{N}^{₁}^{N}^{₂}^{×1}=0, . . . , L−1 selected from a DFT-based codebook matrix for the two polarizations of the antenna array,

$${F}_{1} = [ \begin{matrix}{b}_{0} , … , {b}_{L - 1} & 0 & … & 0 \\ 0 & … & 0 & {b}_{0} , … , {b}_{L - 1}\end{matrix} ] ∈ {ℂ}^{2 {N}_{1} {N}_{2} \times 2 L} .$$

For the type-I codebook, L=1 such that F₁ is simply given by

$${F}_{1} = [ \begin{matrix}{b}_{0} & 0 \\ 0 & {b}_{0}\end{matrix} ] ∈ {ℂ}^{2 {N}_{1} {N}_{2} \times 2} .$$

The spatial codebook comprises an oversampled DFT matrix of dimension N₁N₂×N₁O₁N₂O₂, where O₁ and O₂ denote the oversampling factors with respect to the first and second dimension of the codebook, respectively. The DFT vectors in the codebook are grouped into (q₁, q₂), 0≤q₁≥O₁−1, 0≤q₂≤O₂−1 subgroups, where each subgroup contains N₁N₂ DFT-based vectors, and the parameters q₁ and q₂ are denoted as the rotation oversampling factors, with respect to the first and second dimension of the antenna array, respectively.

The second component or the so-called second stage precoder, F₂(s), is used to combine the selected beam vectors. This means the second stage precoder, F₂(s), corresponds to a selection/combining/co-phasing matrix to select/combine/co-phase the beams defined in F₁ for the s-th configured sub-band. For example, for a rank-1 transmission and Type-I CSI reporting, F₂(s) is given for a dual-polarized antenna array by

$${F}_{2} ( s ) = [ \begin{matrix}1 \\ {e}^{j {δ}_{1}}\end{matrix} ] ,$$

e^{jδ}^{₁} is a quantized co-phasing factor (phase adjustment) between the two orthogonal polarizations of the antenna array. Hence, for the Type-I codebook, a single DFT-beam is selected per transmission layer of the precoding such that the transmission is directed for the strongest path component of the radio channel.

For a rank-1 transmission and Type-II CSI reporting, F₂(s) is given for dual-polarized antenna arrays by

$${F}_{2} ( s ) = [ \begin{matrix}{e}^{j {δ}_{0}} {p}_{0} \\ ⋮ \\ {e}^{j {δ}_{2 L - 1}} {p}_{2 L - 1}\end{matrix} ] ∈ {ℂ}^{2 L \times 1}$$

where pₗ and e^{jδ}^{₁}, l=0, 2, . . . , 2L−1 are quantized amplitude and phase beam-combining coefficients, respectively. For rank-R transmission, F₂(s) contains R vectors, wherein R denotes the transmission rank, where the entries of each vector are chosen to combine single or multiple beams within each polarization.

The selection of the matrices F₁ and F₂(s) is performed by the UE based on reference signals such as CSI-RS and the knowledge of the channel conditions. The selected matrices are indicated in a CSI report in the form of a RI (the RI denotes the rank of the precoding matrices) and a PMI and are used at the gNB to update the multi-user precoder for the next transmission time interval.

In addition to the Type-I codebook, the Rel. 15 3GPP specification also defines a Type-I multi-panel (multi-antenna array) codebook for the case the gNB is equipped with multiple (co-located) antenna panels or antenna arrays that are possibly un-calibrated. The precoder for this codebook is similar to the Type-I codebook where a single DFT beam is applied per transmission layer of the precoding matrix. To take into account different spacing between the antenna panels and/or possible phase calibrations errors (e.g., due to different local oscillators) between the antenna panels, a per-panel co-phasing factor is applied to each panel. For example, for a rank-1 transmission and a gNB that is equipped with N_{g}=2 antenna panels, the Type-I multi-panel CSI reporting is defined as

$$F ( s ) = [ \begin{matrix}{b}_{0} \\ {e}^{j {δ}_{1}} {b}_{0} \\ {e}^{j {δ}_{2}} {b}_{0} \\ {e}^{j {δ}_{1}} {e}^{j {δ}_{2}} {b}_{0}\end{matrix} ] ,$$

where e^{jδ}^{₁} and e^{jδ}^{₂} are quantized co-phasing factors with e^{jδ}^{₂} being a panel-specific co-phasing factor applied to the second panel.

For the 3GPP Rel.-15 dual-stage Type-II CSI reporting, the second stage precoder, F₂(s), is calculated on a subband basis such that the number of columns of F₂=[F₂)^{(r)}(0) . . . F₂^{(r)}(s) . . . F₂^{(r)}(S−1)] for the r-th transmission layer depends on the number of configured CQI subbands S. Here, a subband refers to a group of adjacent physical resource blocks (PRBs). A drawback of the Type-II CSI feedback is the large feedback overhead for reporting the combining coefficients on a subband basis. The feedback overhead increases approximately linearly with the number of subbands and becomes considerably large for large numbers of subbands. To overcome the high feedback overhead of the Rel.-15 Type-II CSI reporting scheme, it has been decided in 3GPP RAN #81 to study feedback compression schemes for the second stage precoder F₂. In several contributions, it has been demonstrated that the number of beam-combining coefficients in F₂ may be drastically reduced when transforming F₂ using a small set of DFT-based basis vectors into the transform domain referred to as the delay domain. The corresponding three-stage precoder relies on a three-stage (i.e., three components) F₁F₂^{(r)}F₃^{(r)} codebook. The first component, represented by the matrix F₁, is identical to the Rel.-15 NR component, is independent of the transmission layer (r), and contains a number of spatial domain (SD) basis vectors selected from the spatial codebook. The second component, represented by the matrix F₃^{(r)}, is layer-dependent and is used to select a number of delay domain (DD) basis vectors from a Discrete Fourier Transform-based (DFT-based) matrix which is also called the delay codebook. The third component, represented by the matrix F₂^{(r)}), contains a number of combining coefficients that are used to combine the selected SD basis vectors and DD basis vectors from the spatial and delay codebooks, respectively.

Assuming a rank-R transmission the three-component precoder matrix or CSI matrix for a configured 2N₁N₂ antenna/CSI-RS ports and configured S subbands is represented for a first polarization of the antenna ports and r-th transmission layer as

$${F}^{( r , 1 )} = {α}^{( r )} {\sum }_{l = 0}^{L - 1} {b}_{l} {\sum }_{d = 0}^{D - 1} {γ}_{1 , l , d}^{( r )} {d}_{d}^{( r )}$$

and for a second polarization of the antenna ports and r-th transmission layer as

$${F}^{( r , 2 )} = {α}^{( r )} {\sum }_{l = 0}^{L - 1} {b}_{l} {\sum }_{d = 0}^{D - 1} {γ}_{2 , l , d}^{( r )} {d}_{d}^{( r )} ,$$

where bᵤ (l=0, . . . , L−1) represents the u-th SD basis vector selected from the spatial codebook, d_{d}^{(r)} (d=0, . . . , D−1) is the d-th DD basis vector associated with the r-th layer selected from the delay codebook, γ_{p,l,d}^{(r)} is the complex delay-domain combining coefficient associated with the u-th SD basis vector, the d-th DD basis vector and the p-th polarization, D represents the number of configured DD basis vectors, and α^{(r)} is a normalizing scalar.

An advantage of the three-component CSI reporting scheme in the above equations is that the feedback overhead for reporting the combining coefficient of the precoder matrix or CSI matrix is no longer dependent on the number of configured CQI subbands (i.e., it is independent from the system bandwidth). Therefore, the above three-component codebook has been recently adopted for the 3GPP Rel.-16 dual-stage Type-II CSI reporting specification.

An inherent drawback of the current CSI Type-II based CSI reporting schemes is that the RI and PMI only contain information of the current channel conditions. Consequently, the CSI reporting rate is related to the channel coherence time which defines the time duration over which the channel is considered to be not varying. This means, in quasi-static channel scenarios, where the wireless device does not move or moves slowly, the channel coherence time is large, and the CSI needs to be less frequently updated. However, if the channel conditions change fast, for example due to a high or fast movement of the wireless device (or UE) in a multi-path channel environment, the channel coherence time is short and the transmit signals experience severe fading caused by a Doppler-frequency spread. For such channel conditions, the CSI needs to be updated frequently which causes a high feedback overhead. Especially, for NR systems (Rel. 16) that are likely to be more multi-user centric, the multiple CSI reports from users (or UEs) in highly dynamic channel scenarios will drastically reduce the overall efficiency of the communication system.

There are thus drawbacks with the known solutions as described above and the present invention according to the present disclosure addresses these drawbacks.

### SUMMARY

It is an objective of the embodiments herein to provide methods and apparatuses for CSI feedback reporting for a codebook-based precoding in a wireless communications network such as advanced 5G networks.

According to an aspect of some embodiments herein, there is provided a method performed by a wireless device (or user equipment) for generating and reporting or transmitting a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components. The method comprising:
receiving a CSI report configuration from a network node;
determining one or more time- and/or frequency-domain components from a first set of time- and/or frequency-domain components for a first subset of combination coefficients,
determining one or more time- and/or frequency-domain components from a second set of time- and/or frequency-domain components for a second subset of combination coefficients,
determining one or more spatial domain components for the set of linear combination coefficients, and;
generating and transmitting, to the network node, a CSI report, the CSI report comprising an indication of the determined spatial-, frequency- and time-domain components, and combination coefficients of the precoder vector or matrix.

According to another aspect of some embodiments herein, there is provided a method performed by a wireless device for generating and transmitting a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
receiving a CSI report configuration from a network node;
determining from a set of spatial-domain components a subset of spatial-domain components,
determining from a set of time-domain components a subset of time-domain components,
determining from a set of frequency-domain components a subset of frequency-domain components,
determining for each selected spatial-domain component from the subset of spatial-domain components a spatial-domain-specific subset comprising one or more time-domain components selected from the subset of time-domain components and one or more frequency-domain components selected from the subset of frequency-domain components,
determining a set of combination coefficients for combining the selected time-domain component(s) and frequency-domain component(s) from the spatial-domain-specific subsets for each spatial-domain-specific subset, and
generating and transmitting or reporting, to the network node, a CSI report, the CSI report comprising an indication of the selected spatial-, frequency- and time-domain components, and combination coefficients of the precoder vector or matrix.

According to yet another aspect of some embodiments herein, there is provided a method performed by a wireless device for generating and transmitting or reporting a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
receiving a CSI report configuration from a network node;
receiving, from the network node, a higher layer configuration indicating a subset of spatial domain components from a set of spatial domain components and a maximum allowable average amplitude value, or power, for restricting an average amplitude, or power, of the combination coefficients associated with the spatial-domain component in the subset of spatial-domain components;
determining one or more spatial-domain components from the a of spatial-domain components, one or more time-domain components from a set of time-domain components, and one or more frequency-domain components from a set of frequency-domain components, and
generating and transmitting or reporting, to the network node, a CSI report, the CSI report comprising an indication of the determined spatial-, frequency- and time-domain components, and combination coefficients of the precoder vector or matrix.

According to another aspect of some embodiments herein, there is provided a method performed by a network node for receiving a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, The method comprising: transmitting to a wireless device a CSI report configuration, and receiving, from the wireless device, a CSI report, the CSI report comprising an indication of determined spatial-, frequency- and time-domain components, and combination coefficients of the precoder vector or matrix; wherein the content of the CSI report is determined by the wireless device according to claim 10.

According to another aspect of some embodiments herein, there is provided a method performed by a network node for receiving a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components. The method comprising: transmitting a CSI report configuration to a wireless device; and receiving, from the wireless device, a CSI report, the CSI report comprising an indication of determined spatial-, frequency- and time-domain components, and combination coefficients of the precoder vector or matrix; wherein the content of the CSI report is determined by the wireless device according to claim 15.

According to another aspect of some embodiments herein, there is provided a method performed by a network node for receiving a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
transmitting, to a wireless device, a CSI report configuration;
transmitting, to the wireless device, a higher layer configuration indicating a subset of spatial domain components from a set of spatial domain components and a maximum allowable average amplitude value, or power, for restricting an average amplitude, or power, of the combination coefficients associated with the spatial-domain component in the subset of spatial-domain components; and
receiving, from the wireless device, a CSI report, the CSI report comprising an indication of determined spatial-, frequency- and time-domain components, and combination coefficients of the precoder vector or matrix; wherein the content of the CSI report is determined by the wireless device according to claim 1.

According to another aspect of some embodiments herein, there is provided a wireless device (or UE) comprising a processor and a memory containing instructions executable by the processor, whereby said wireless device is operative or configured to perform any one of the embodiments presented in the detailed description related to the actions performed by the wireless device, such as in the method presented in this disclosure.

According to yet another aspect of embodiments herein, there is provided a network node comprising a processor and a memory containing instructions executable by the processor, whereby said network node is operative or configured to perform any one of the embodiments presented in the detailed description related to the network node, such as in at least method/procedure presented herein.

There is also provided a computer program comprising instructions which when executed on at least one processor of the wireless device, cause the at least said one processor to carry out the actions or method steps presented herein.

There is also provided a computer program comprising instructions which when executed on at least one processor of the network node, cause the at least said one processor to carry out the method steps presented herein.

A carrier is also provided containing the computer program, wherein the carrier is one of a computer readable storage medium; an electronic signal, optical signal, or a radio signal.

Advantages achieved by the embodiments of the present invention include significantly reducing the feedback overhead and the computational complexity at the wireless device for codebook-based CSI reporting CSI reporting.

### BRIEF DESCRIPTION OF THE DRAWINGS

Embodiments of the present invention are now described in further detail with reference to the accompanying drawings, in which:

FIG. 1 shows a schematic representation of a wireless communications system;

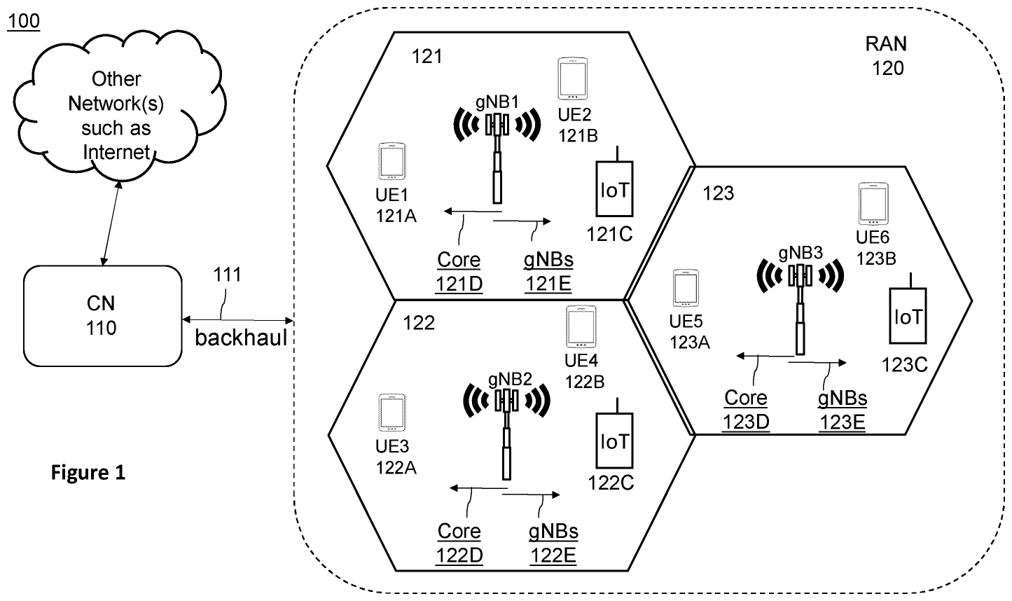

FIG. 2 shows a block-based model of a MIMO DL transmission using codebook-based-precoding in accordance with LTE Release 8;

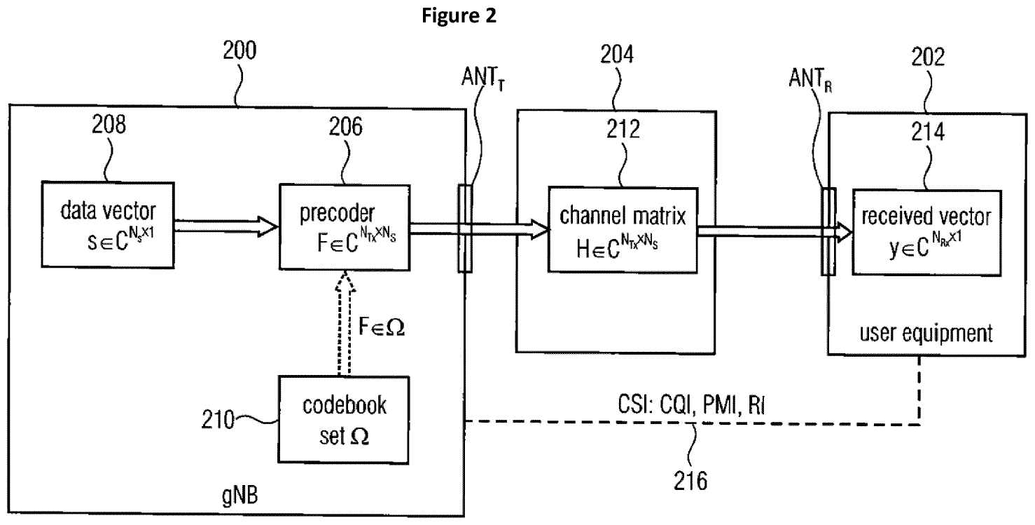

FIG. 3 is a schematic representation of a wireless communications system for communicating information between a transmitter and a plurality of receivers, wherein embodiments herein may be employed;

FIG. 4A illustrates a flowchart of a method performed by a wireless device (or UE) according to some embodiments herein;

FIG. 4B illustrates a flowchart of a method performed by a wireless device (or UE) according to some embodiments herein;

FIG. 4C illustrates a flowchart of a method performed by a wireless device (or UE) according to some embodiments herein;

FIG. 5 is a block diagram depicting a wireless device according to some embodiments herein;

FIG. 6 is a block diagram depicting a network node according to some embodiments herein.

### DETAILED DESCRIPTION

In the following, a detailed description of the exemplary embodiments is described in conjunction with the drawings, in several scenarios to enable easier understanding of the solution(s) described herein.

The invention according to the present embodiment addresses the previously described drawbacks. In detail, methods that significantly reduce the feedback overhead and the computational complexity at the user equipment for codebook-based CSI reporting are proposed.

Further, to overcome the problems previously mentioned with regards the state of the art, the invention of the present disclosure proposes extensions to the NR Type-II CSI reporting to allow time-domain based downlink precoding for time-varying multipath propagation channels. Compared to the state-of-the-art CSI reporting schemes, it is proposed to extend the CSI reporting schemes by a Doppler component that allows a network node time-domain-based channel prediction and precoding of downlink signals. Moreover, such a Doppler component of the CSI report drastically reduces the CSI overhead over time as the CSI describes the channel evolution over time in a compact manner.

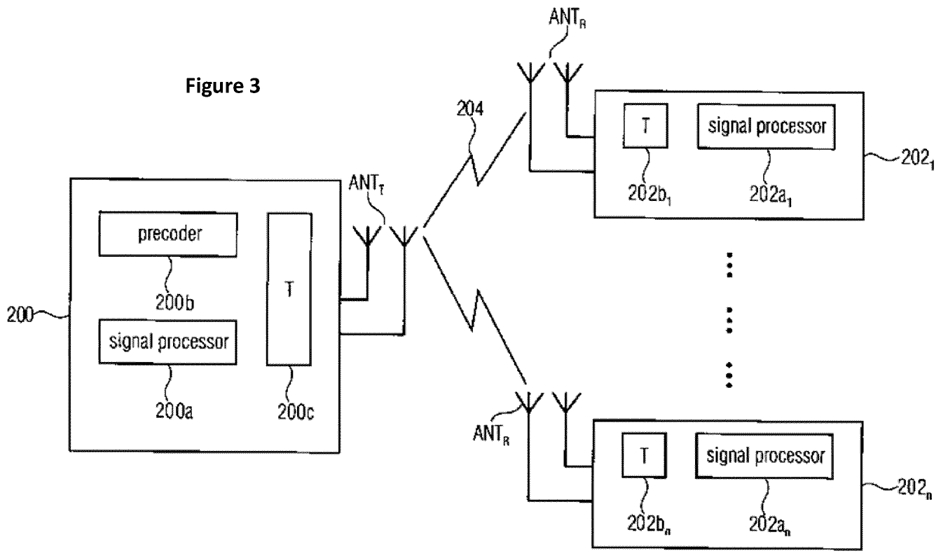

Referring to FIG. 3, there is depicted a schematic representation of a wireless communications system for communicating information between a transmitter 200, like a base station or a gNB, and a plurality of communication devices 202₁ to 202ₙ, like wireless devices or UEs, which are served by the base station 200. The base station 200 and the UEs 202 may communicate via a wireless communication link or channel 204, like a radio link. The base station 200 includes one or more antennas ANT_{T} or an antenna array having a plurality of antenna elements, and a signal processor 200a. The UEs 202 include one or more antennas ANT_{R} or an antenna array having a plurality of antennas, a signal processor 202a₁, 202aₙ, and a transceiver 202b₁, 202bₙ. The base station 200 and the respective UEs 202 may operate in accordance with the inventive teachings described herein.

### Precoder Structure and CSI Reporting

It should be noted that the term “precoding” equally means “precoder”. Hence, throughout this disclosure precoding and precoder are used interchangeably.

The term ‘beam’ is used to denote a spatially selective/directive transmission of an outgoing signal or reception of an incoming signal which is achieved by precoding/filtering the signal at the antenna ports of the device (UE or gNB) with a particular set of coefficients. The words precoding or precoder or filtering may refer to processing of the signal in the analog or digital domain. The set of coefficients used to spatially direct a transmission/reception in a certain direction may differ from one direction to another direction. The term ‘Tx beam’ denotes a spatially selective/directive transmission and the term ‘Rx beam’ denotes a spatially selective/directive reception. The set of coefficients used to precode/filter the transmission or reception is denoted by the term ‘spatial filter’. The term ‘spatial filter’ is used interchangeably with the term ‘beam direction’ in this document as the spatial filter coefficients determine the direction in which a transmission/reception is spatially directed to.

In a certain embodiment, each precoder vector or matrix of the plurality of precoder vectors or matrices is represented by a linear combination of spatial-domain components, frequency-domain components and time-domain components, and a set of combining/combination coefficients for combining the spatial-domain components, frequency-domain components and time-domain components. The plurality of precoder vectors or matrices may be indicated in the CSI report by indicating the spatial-domain components, frequency-domain components and time-domain components and the set of linear combination coefficients.

The term ‘combination coefficient’ and the term ‘combining coefficient’ in this disclosure can be used interchangeably.

In general, and in accordance with some non-limiting exemplary effects achieved by the embodiments herein include a wireless device receiving from a network node or gNB a CSI report configuration via a higher layer (e.g., RRC) indicating one or more antenna port groups or CSI-RS resources associated with one or more antenna or CSI-RS ports. An antenna port group may comprise or indicate a number of antenna or CSI-RS ports and is associated with specific set of time- and frequency-domain resources of the DL channel. In some examples, an antenna port group is a CSI-RS resource that comprises or indicates a number of antenna or CSI-RS ports. The wireless device may be configured (via the CSI report configuration) with multiple antenna port groups (e.g., multiple CSI-RS resources). Note that, in some examples, the wireless device may be configured with multiple antenna port groups, wherein each antenna port group indicates one or more antenna or CSI-RS ports and all antenna port groups are associated with or are included in a single CSI-RS resource. In some examples, the wireless device may be configured with N antenna port groups associated with a single CSI-RS resource, wherein N=2 or N≥2. The CSI-RS ports of the configured antenna port groups may be identical or different. In certain embodiments, the antenna port groups configured to the wireless device are associated with different time domain resources of the DL channel. The CSI report configuration may also comprise the parameters N₁ and N₂ indicating the number of antenna or CSI-RS ports for a first dimension and second dimension, respectively.

The precoder vectors or matrices may be defined over a number of subbands, N₃, and time instances, N₄. The bandwidth of the DL channel may be divided into a number of subbands, wherein each precoder vector or matrix is associated with a sub-band. In certain embodiments, the number of subbands of the precoder is an integer number (or a real number smaller than 1) of the number of CQI subbands configured to the wireless device. The number of CQI subbands may be indicated to the wireless device via the CSI report configuration.

Each precoder vector or matrix may also be associated with a time instant of the DL channel. In some examples, the number of time-instances, N₄, the precoder is associated with may be identical to the number of antenna port groups configured to the wireless device. In certain embodiments, the number of time-instances is an integer number of the number of antenna port groups, M, configured to the wireless device. This means, N₄=u·M, where u=1 or u is any number greater than 1.

The precoder vectors or matrices are determined by the wireless device based on measurements of the received reference signals (e.g., CSI-RS), wherein the reference signals are provided by another wireless device or the network node. The reference signals are configured to the wireless device via the CSI report configuration. The wireless device is configured to perform CSI measurements on the antenna port groups and to determine based on the CSI measurements the precoder vectors or matrices, and to indicate the precoder vectors or matrices in the CSI report. The wireless device may perform the measurements on the CSI-RS ports over multiple time instances (e.g., OFDM symbols, or slots, or frames). In certain embodiments, the number of time instances may correspond to the size (or length) of a basis vector in a third basis set (see below). In certain embodiments, the number of time instances may correspond to the number of antenna port groups or CSI-RS resource(s) configured to the wireless device to determine the precoder vectors or matrices. The number of time-instances (or CSI-RS resources or antenna port groups) is indicated to the wireless device, e.g., via a higher layer, or is fixed in the NR specifications and known by the wireless device or selected by the wireless device and indicated in the CSI-report. The wireless device generates and transmits the CSI report indicating the precoder vector or matrix via an uplink channel to a network node, gNB, or another wireless device.

### Spatial-Domain Components of the Precoder

In certain embodiments, the wireless device is configured to determine one or more spatial domain components for the set of linear combination coefficients of the precoder. Each spatial-domain component corresponds to a basis vector. A set of spatial-domain components may correspond to a first basis set. For determining the precoder vectors or matrices, the wireless device is configured to select one or more spatial-domain components from the first basis set. A basis vector from the first basis set is associated with a set of antenna ports or CSI-RS ports across the antenna port groups. The set of antenna ports or CSI-RS ports may be associated with a first and second polarization. A first set of antenna or CSI-RS ports may be associated with a first polarization, and a second set of antenna or CSI-RS ports may be associated with a second polarization. The selection of the one or more basis vectors (one or more spatial-domain components) from the first basis set can be polarization-common or polarization-specific. In case of polarization-common selection, the selected basis vectors from the first basis set are common to the two polarizations of the antenna or CSI-RS ports configured to the wireless device. In case of polarization-specific selection, the selected basis vectors from the first set are independently selected by the wireless device for the two polarizations of the antenna or CSI-RS ports configured to the wireless device. In an exemplary embodiment, the wireless device selects L basis vectors of the precoding vector or matrix from the first basis set, and indicates the selected L basis vectors in the CSI report. In some examples, the selected L basis vectors are polarization-common, and hence identical for the first and second set of antenna or CSI-RS ports. In some examples, the selected L basis vectors are polarization-dependent, and hence possibly different to the first or second set of antenna or CSI-RS ports. In some examples, the selected L basis vectors are layer-dependent and differ for a subset of transmission layers or per transmission layer of the precoder. In such a case, the basis vectors are selected independently per layer subset or layer of the precoder. In some other examples, the selected L basis vectors are layer-independent and identical for all layers of the precoder.

In certain embodiments, the first basis set is an orthogonal basis set, i.e., the basis set comprises a number of orthogonal basis vectors. For example, the first basis set is a DFT- or DCT-based basis set. In certain embodiments, the first basis set is defined by an DFT or IDFT basis set, or an oversampled DFT or IDFT basis set. In certain embodiments, the first basis set comprises a set of Discrete Cosine Transform (DCT)-based vectors. When the first basis set is defined by an DFT-based (DFT or IDFT) basis set, the first basis set is represented by a DFT- or IDFT-matrix. In certain embodiments, the first basis set is defined by a rotated DFT-based basis, wherein the indices of the DFT-based vectors are defined by i₁=O₁i₁₁+q₁, i₁₁=0, . . . , N₁−1, i₂=O₂i₂₂+q₂, i₂₂=0, . . . , N₂−1 with q₁=0, . . . , O₁−1 q₂=0, . . . , O₂−1 be the rotation factors of the rotated DFT-based basis, N₁ and N₂ denote the antenna ports with respect to a first and a second dimension, respectively, and O₁ and O₂ denote the oversampling factors with respect to the first and second dimension, respectively. In such cases, the rotated DFT-based basis is selected from an oversampled DFT-based basis comprising O₁O₂N₁N₂ DFT-based vectors. The rotation factors may be selected by the wireless device, or configured to the wireless device, or reported by the wireless device as a part the CSI-report. The oversampling factors may be configured to the wireless device.

In certain embodiments, the first basis set is an orthogonal basis set, i.e., the basis set comprises a number of orthogonal basis vectors comprising an identity matrix. Each vector of size P_{CSI-RS} or P_{CSI-RS}/2 from the basis set is associated with a CSI-RS port and comprises P_{CSI-RS}−1 or P_{CSI-RS}/2−1 zeros and a single one, wherein P_{CSI-RS} or P_{CSI-RS}/2(e.g., per polarization of the antenna ports) is the number of antenna ports of one or multiple antenna port groups.

### Frequency-Domain Components of the Precoder

In certain embodiments, the wireless device is configured to determine one or more frequency domain components for the set of linear combination coefficients of the precoder. Each frequency-domain component of the precoder corresponds to a basis vector. A set of frequency-domain components corresponds to a second basis set. For determining the precoder vectors or matrices, the wireless device is configured to select one or more frequency-domain components (i.e., basis vectors) from the second basis set. A basis vector from the second basis set is associated with a number of subbands, N₃, of the bandwidth of the DL channel. A subband may comprise a number of Physical Resource Blocks (PRBs). In certain embodiments, the number of subbands, N₃, is dependent on the number of CQI subbands, or on the CQI subband size configured to the wireless device.

In certain embodiments, the second basis set is defined by an orthogonal basis set, i.e., the basis set comprises a number of orthogonal vectors. For example, the second basis set is a DFT- or DCT-based basis. In certain embodiments, the second basis set is defined by an DFT or IDFT basis, or an oversampled DFT or IDFT basis. In certain embodiments, the second basis set comprises a set of Discrete Cosine Transform (DCT)-based vectors. When the second basis set is defined by an DFT-based (DFT or IDFT) basis, the second basis set may be represented by a DFT- or IDFT-matrix. In certain embodiments, the second basis set is defined by a rotated DFT-based basis, wherein the indices of the DFT-based vectors are defined by d₃=O₃₃+q₃, i₃=0, . . . , N₃−1 with q₃=0, . . . , O₃−1 be the rotation factor of the rotated DFT-based basis. In such cases, the rotated DFT-based basis is selected from an oversampled DFT-based basis comprising O₃N₃ DFT-based vectors. This means, the basis set corresponding to the frequency-domain components is an oversampled DFT- or DCT-based matrix comprising O₃ orthogonal DFT- or DCT-based matrices. The rotation factor may be selected by the wireless device, or configured to the wireless device, or reported by the wireless device as a part the CSI-report. In certain embodiments, the number of frequency subbands defines the length (N₃) of the basis vectors of the second basis set. The number of frequency subbands may be indicated to the wireless device, e.g., via a higher layer, or may be fixed in the NR specifications and known by the wireless device or selected by the wireless device and indicated in the CSI-report.

In certain embodiments, the set of frequency-domain components is a basis set represented by DFT-based or DCT-based matrix or an oversampled DFT-based or DCT-based matrix, and the basis set comprises a number of basis vectors that represent the frequency-domain components, and each basis vector is a DFT- or DCT-based vector.

In certain embodiments, the basis vector set of the frequency-domain components is an oversampled DFT- or DCT-based matrix comprising O₃ orthogonal DFT- or DCT-based matrices.

### Time-Domain Components of the Precoder

In certain embodiments, the wireless device is configured to determine one or more time domain components for the set of linear combination coefficients of the precoder. Each time-domain component of the precoder corresponds to a basis vector. The set of time-domain components corresponds to a third basis (vector) set comprising a number of basis vectors. For determining the precoder vectors or matrices, the wireless device is configured to select one or more time-domain components (i.e., basis vectors) from the third basis set. In some examples, the length of the basis vectors (i.e., the number of entries of each basis vector) is defined by an integer number of the antenna port groups (as described above) configured to the wireless device. The wireless device is configured to perform measurements on the reference signals (i.e., on the configured antenna port groups) received by the wireless device over N₄ time instances. Note that a time-instance of the DL channel may be associated with an OFDM symbol, or a set of symbols, or a slot or a radio frame.

In certain embodiments, the third basis set comprises a number of basis vectors. The third basis set may be defined by a DFT or IDFT basis, or an oversampled DFT or IDFT basis. In certain embodiments, the third basis set comprises a set of Discrete Cosine Transform (DCT)-based vectors. When the third basis set is defined by a DFT-based (DFT or IDFT) basis, the third basis set may be represented by a DFT- or IDFT-matrix. In certain embodiments, the third basis set is defined by a rotated DFT-based basis, wherein the indices of the DFT-based vectors are defined by d₄=O₄i₄+q₄, i₄=0, . . . , N₄−1 with q₄=0, . . . , O₄−1 be the rotation factor of the rotated DFT-based basis. In such cases, the rotated DFT-based basis is selected from an oversampled DFT-based basis comprising O₄N₄ DFT-based vectors. This means, the basis set corresponding to the time-domain components is an oversampled DFT- or DCT-based matrix comprising O₄ orthogonal DFT- or DCT-based matrices. The rotation factor may be selected by the wireless device, or is configured to the wireless device, or is reported by the wireless device as a part of the CSI-report. In certain embodiments, the number of time-instances defines the length (N₄) of the basis vectors of the third basis set, and each entry of a basis vector is associated with a time instant of the precoder vector or matrix. When the third basis set is defined by an N₄×N₄ DFT-based (DFT- or IDFT-) matrix, the phases of the elements of each basis vector increase (or decrease) with respect to the element index. Hence, each basis vector from the third basis set is associated with a Doppler frequency in the transformed domain. The N₄ basis vectors of the third basis set are hence associated with N₄ different Doppler frequencies. The wireless device selects the basis vectors (i.e., the Doppler frequencies) for the precoder based on the measured reference signals.

### Oversampling

In certain embodiments, the wireless device determines for a first subset of combining or combination coefficients one or more time- and/or frequency-domain components from a first set of time- and/or frequency-domain components and for a second subset of combining coefficients one or more time- and/or frequency-domain components from a second set of time- and/or frequency-domain components. The elements/vectors of the first set of time- and/or frequency-domain components are different to the elements/vectors of the second set of time- and/or frequency-domain components.

In a sub-embodiment, the wireless device divides the set of combining coefficients in at least two subsets of combining coefficients. For the first subset of combining coefficients, the wireless device determines one or more time- and/or frequency-domain components from a first set of time- and/or frequency-domain components and for the second subset of combining coefficients, the wireless device determines one or more time- and/or frequency-domain components from a second set of time- and/or frequency-domain components. The time- and/or frequency-domain components from the first set or second set can be time-domain components, frequency-domain components, or time- and frequency-domain components.

The number of combining or combination coefficients per subset can be identical or different. In a first example, the first subset of combining coefficients comprises one combining coefficient (e.g., per layer) and the second subset of combining coefficients comprises the remaining combining coefficients of the precoder. In a second example, the first subset of combining coefficients comprises L or L/2 combining coefficients for L or L/2 (spatial-domain components) basis vectors (e.g., per layer, or subset of layers, or all layers), and the second subset of combining coefficients comprises the remaining combining coefficients of the precoder.

In certain embodiments, the first set and second set of time- and/or frequency-domain components comprise only time-domain components from a first vector basis set, A₄₁, and a second basis vector set, A₄₂, respectively, wherein the first basis set and second basis set comprise a number of basis vectors associated with the time-domain components of the precoder. Each basis vector in A₄₁ or A₄₂ may be associated with a Doppler-frequency, wherein the basis set A₄₁ comprises a number of basis vectors associated with Doppler frequencies of a first resolution, and the basis set A₄₂ comprises a number of basis vectors associated with Doppler frequencies of a second resolution. In one option, the first resolution is higher than the second resolution. In another option, the first resolution is identical to the second resolution. In some examples, the basis set A₄₁ comprises N_{4,1} basis vectors associated with N_{4,1} Doppler-frequencies (or Doppler-frequency components), and the basis set A₄₂ comprises N_{4,2} basis vectors associated with N_{4,2} Doppler-frequencies (or Doppler-frequency components). The number of basis vectors of the two basis sets can be identical or different. The basis vectors of the two basis sets may provide different Doppler-frequency resolutions. In some examples, the N_{4,1} basis vectors of the basis set A₄₁ are associated with Doppler frequencies f_{4,1,0}, f_{4,1,1}, f_{4,1, N}_{_{4,1}}₋₁, and the N_{4,2} basis vectors of the basis set A_{4,2} are associated with the Doppler frequencies f_{4,2,0}, f_{4,2,1} . . . , f_{4,2, N}_{_{4,2}}₋₁. The smallest difference of the Doppler-frequencies of two basis vectors from the first basis set may be given by Δf_{4,1}=min (|f_{4,1,i}−f_{4,1,j}|), ∀i,j. The smallest difference of the Doppler-frequencies of two basis vectors from the second basis set may be given by Δf_{4,2}=min (|f_{4,2,i}−f_{4,2,j}|), ∀i,j. In some examples, the resolution of the Doppler frequencies associated with the basis vectors of A_{4,1} is higher than the resolution of the Doppler frequencies associated with the basis vectors of A_{4,2}. In such cases, it follows that Δf_{4,1}<Δf_{4,2}. In certain embodiments, the first basis set, A_{4,1}, and the second basis set, A_{4,2}, comprise DFT-based or oversampled DFT-based basis vectors. In some examples, the first basis set A_{4,1} comprises vectors of an oversampled DFT-based matrix, and the second basis set A_{4,2} comprises vectors of an DFT-based (i.e., non-oversampled) matrix. In some examples, the first basis set A_{4,1} is defined by an oversampled DCT-based (or rotated DCT-based) matrix, and the second basis set A_{4,2} is defined by an DCT-based (i.e., non-oversampled) matrix.

In certain embodiments, the first set and second set of time- and/or frequency-domain components comprise only frequency-domain components from a first basis vector set, A_{3,1}, and a second basis vector set, A_{3,2}, respectively, wherein the first basis vector set and second basis vector set comprise a number of basis vectors associated with the frequency-domain components of the precoder. Each basis vector in basis vector set A_{3,1} or basis vector set A_{3,2} may be associated with a delay, wherein the basis vector set A_{3,1} comprises a number of basis vectors associated with delays of a first resolution, and the basis vector set A_{3,2} comprises a number of basis vectors associated with delays of a second resolution. In one option, the first resolution is higher than the second resolution. In another option, the first resolution is identical to the second resolution. In some examples, the basis set A_{3,1} comprises N_{3,1} basis vectors associated with N_{3,1} delays (or delay components), and the basis set A_{3,2} comprises N_{3,2} basis vectors associated with N_{3,2} delays (or delay components). The number of basis vectors of the two basis vector sets can be identical or different. The basis vectors of the two basis sets can provide different delay resolutions. In some examples, the N_{3,1} basis vectors of the basis set A_{3,1} are associated with delays d_{3,1,0}, d_{3,1,1} . . . , d_{3,1, N}_{_{3,1}}₋₁, and the N_{3,2} basis vectors of the basis set B_{3,2} are associated with the delays d_{3,2,0}, d_{3,2,1} . . . , d_{3,2,N}_{_{3,2}}₋₁. The smallest difference of the delays of two basis vectors from the first basis set may be given by Δd_{3,1}=min (|d_{3,1,i}−d_{3,1,j}|), ∀i,j. The smallest difference of the delays of two basis vectors from the second basis set may be given by Δd_{3,2}=min (|d_{3,2,i}−d_{3,2,j}|), ∀i,j. In some examples, the resolution of the delays associated with the basis vectors of A_{3,1} is higher than the resolution of the delays associated with the basis vectors of A_{3,2}, such that Δd_{3,1}<Δd_{3,2}. In certain embodiments, the first basis set, A_{3,1}, and the second basis set, A_{3,2}, comprise DFT-based or oversampled DFT-based basis vectors. In some examples, the first basis set A_{3,1} comprises vectors of an oversampled DFT-based matrix, and the second basis set A_{3,2} comprises vectors of an DFT-based (i.e., non-oversampled) matrix. In some examples, the first basis set A_{3,1} is defined by an oversampled DCT-based (or rotated DCT-based) matrix, and the second basis set A_{3,2} is defined by a DCT-based (i.e., non-oversampled) matrix.

In certain embodiments, the first and second sets of time- and/or frequency-domain components comprise a first set and a second set of frequency-domain and a first set and a second set of time-domain components, wherein
the first set and the second set of frequency domain components are from a first basis set, A_{3,1}, and a second basis set, A_{3,2}, respectively, wherein A_{3,1} and A_{3,2} comprise a number of basis vectors associated with the frequency-domain components of the precoder, and
the first set and the second set of time domain components are from a first basis set, A_{4,1}, and a second basis set, A_{4,2}, respectively, wherein A_{4,1} and A_{4,2} comprise a number of basis vectors associated with the time-domain components of the precoder.

Similar to above, each basis vector in A_{3,1} or A_{3,2} may be associated with a delay, wherein the basis set A_{3,1} comprises a number of basis vectors associated with delays of a first resolution, and the basis set A_{3,2} comprises a number of basis vectors associated with delays of a second resolution. In one option, the first resolution is higher than the second resolution. In another option, the first resolution is identical to the second resolution. In some examples, the basis set A_{3,1} comprises N_{3,1} basis vectors associated with N_{3,1} delays (or delay components), and the basis set A_{3,2} comprises N_{3,2} basis vectors associated with N_{3,2} delays (or delay components). The number of basis vectors of the two basis sets can be identical or different. The basis vectors of the two basis sets may provide different delay resolutions. In some examples, the N_{3,1} basis vectors of the basis set A_{3,1} are associated with delays d_{3,1,0}, d_{3,1,1} . . . , d_{3,1,N}_{_{3,1}}₋₁, and the N_{3,2} basis vectors of the basis set A_{3,2} are associated with the delays d_{3,2,0}, d_{3,2,1} . . . , d_{3,2,N}_{_{3,2}}₋₁. The smallest difference of the delays of two basis vectors from the first basis set may be given by Δd_{3,1}=min (|d_{3,1,i}−d_{3,1,j}|), ∀i,j. The smallest difference of the delays of two basis vectors from the second basis set may be given by Δd_{3,2}=min (|d_{3,2,i}−d_{3,2,j}|), ∀i,j. In some examples, the resolution of the delays associated with the basis vectors of A_{3,1} is higher than the resolution of the delays associated with the basis vectors of A_{3,2}, such that Δd_{3,1}<Δd_{3,2}. Each basis vector in A_{4,1} or A_{4,2} may be associated with a Doppler-frequency, wherein the basis set A_{4,1} comprises a number of basis vectors associated with Doppler frequencies of a first resolution, and the basis set A_{4,2} comprises a number of basis vectors associated with Doppler frequencies of a second resolution. In one option, the first resolution is higher than the second resolution. In another option, the first resolution is identical to the second resolution. In some examples, the basis set A_{3,1} comprises N_{4,1} basis vectors associated with N_{4,1} Doppler-frequencies (or Doppler-frequency components), and the basis set A_{4,2} comprises N_{4,2} basis vectors associated with N_{4,2} Doppler-frequencies (or Doppler-frequency components). The number of basis vectors of the two basis sets can be identical or different. The basis vectors of the two basis sets may provide different Doppler-frequency resolutions. In some examples, the N_{4,1} basis vectors of the basis set A_{3,1} are associated with Doppler frequencies f_{4,1,0}, f_{4,1,1} . . . , f_{4,1,N}_{_{4,1}}₋₁, and the N_{4,2} basis vectors of the basis set A_{4,2} are associated with the Doppler frequencies f_{4,2,0}, f_{4,2,1} . . . , f_{4,2,N}_{_{4,2}}₋₁. The smallest difference of the Doppler-frequencies of two basis vectors from the first basis set may be given by Δf_{4,1}=min (|f_{4,1,i}−f_{4,1,j}|), ∀i,j. The smallest difference of the Doppler-frequencies of two basis vectors from the second basis set may be given by Δf_{4,2}=min (If_{4,2,i}−f_{4,2,j}|), ∀i,j. In some examples, the resolution of the Doppler frequencies associated with the basis vectors of A_{4,1} is higher than the resolution of the Doppler frequencies associated with the basis vectors of A_{4,2}, it follows that Δf_{4,1}<Δf_{4,2}. In certain embodiments, the first basis set, A_{4,1}, and the second basis set, A_{4,2}, comprise DFT-based or oversampled DFT-based basis vectors. In some examples, the first basis set A_{4,1} comprises vectors of an oversampled DFT-based matrix, and the second basis set A_{4,2} comprises vectors of an DFT-based (i.e., non-oversampled) matrix. In some examples, the first basis set A_{4,1} is defined by an oversampled DFT-based (or rotated DFT-based) matrix, and the second basis set A_{4,2} is defined by an DFT-based (i.e., non-oversampled) matrix. In certain embodiments, the first basis set, A_{3,1}, and the second basis set, A_{3,2}, comprise DFT-based or oversampled DFT-based basis vectors. In some examples, the first basis set A_{3,1} comprises vectors of an oversampled DFT-based matrix, and the second basis set A_{3,2} comprises vectors of an DFT-based (i.e., non-oversampled) matrix. In some examples, the first basis set A_{3,1} is defined by an oversampled DFT-based (or rotated DFT-based) matrix, and the second basis set A_{3,2} is defined by an DFT-based (i.e., non-oversampled) matrix.

Rotated DFT-Based Basis Sets for Time and/or Frequency Components of the Precoder

In certain embodiments, the wireless device determines one or more time- and/or frequency-domain components from a first set of time- and/or frequency-domain components for a first subset of combining/combination coefficients and one or more time- and/or frequency-domain components from a second set of time- and/or frequency-domain components for a second subset of combining coefficients. The elements/vectors of the first set of time- and/or frequency-domain components are different to the elements/vectors of the second set of time- and/or frequency-domain components.

Note that the first set of time- and/or frequency-domain components can be identical or different to the second set of time- and/or frequency-domain components.

The first or second set of time- and/or frequency-domain components may comprise only time-domain components, only frequency-domain components, or time-domain and frequency-domain components.

In a certain embodiment, the set of combining/combination coefficients comprises at least two or multiple (greater than two) subsets of combining coefficients, wherein for each subset of combining coefficients the wireless device determines one or more time- and/or frequency-domain components from a set of time- and/or frequency-domain components specific to the subset of combining coefficients. The sets of time- and/or frequency-domain components can be identical or different for different subsets of combining coefficients.

The set of time-domain and/or frequency-domain components may comprise only time-domain components, only frequency-domain components, or time-domain and frequency-domain components.

In some examples, the subsets of combining coefficients are proper subsets of combining or combination coefficients. By a proper subset is meant that if a set A contains x elements, a proper subset of the set A contains less than x elements.

In certain embodiments, the first, second or each of the multiple sets of the time- and/or frequency-domain components is defined by a rotated DFT-based basis set (see above) for the time- or frequency-domain components of the precoder. The rotation factor(s) of the DFT-based basis set(s) is either determined by the wireless device and reported, or configured to the wireless device, or fixed in the NR specifications and hence known to the wireless device. In some examples, the rotation factor(s) is/are contained in the CSI report.

In certain embodiments, the first and second set of the time- and/or frequency-domain components is defined by two rotated DFT-based basis sets (see above) for the time- and frequency-domain components of the precoder. The first rotated DFT-based basis set corresponds to the set of time domain components and the second rotated DFT-based basis sets corresponds to the set of frequency domain components of the precoder. The rotation factors of the DFT-based basis sets are either determined by the wireless device and reported, or configured to the wireless device, or fixed in the NR specifications and hence known to the wireless device. In some examples, the rotation factors are contained in the CSI report.

In certain embodiments, multiple sets of time- and/or frequency-domain components is defined by multiple rotated DFT-based basis sets (see above) for the time- and frequency-domain components of the precoder. The rotation factors of the DFT-based basis sets are either determined by the wireless device and reported, or configured to the wireless device, or fixed in the NR specifications and hence known to the wireless device. In some examples, the rotation factors are contained in the CSI report.

In certain embodiments, each set of time- and/or frequency-domain components associated with a subset of combining coefficients is a rotated DFT-based basis set, wherein the rotation factor of the DFT-basis set is determined by the wireless device. In some examples, the rotation factor of the DFT-based basis is reported and contained in the CSI report.

In certain embodiments, the set of combining/combination coefficients comprises multiple subsets of combining coefficients, wherein each subset comprises all combining coefficients that are associated with the same spatial-domain component (selected/determined from the set of spatial-domain components) for each polarization of the antenna ports or across the two polarizations of the antenna ports.

In certain embodiments, the set of combining coefficients comprises at least two subsets of combining coefficients for each spatial-domain component (for each polarization of the antenna ports or across the two polarizations of the antenna ports) associated with the combining coefficients of the at least two subsets. In some examples, the first subset of combining coefficients comprises only a single combining coefficient (e.g., the strongest combining coefficient) and the remaining subset(s) comprise(s) the remaining combining coefficients.

In certain embodiments, the set of combining coefficients comprises multiple subsets of combining coefficients, wherein each subset comprises combining coefficients that are associated with a subset of spatial-domain components of the antenna ports.

In certain embodiments, the set of combining coefficients comprises multiple subsets of combining coefficients, wherein each subset comprises combining coefficients that are associated with spatial-domain components for each polarization of the antenna ports or across the two polarizations of the antenna ports and a subset of layers of the precoder.

In certain embodiments, the set of combining coefficients comprises multiple subsets of combining coefficients, wherein each subset comprises combining coefficients that are associated with a subset of spatial-domain components of the antenna ports and a subset of layers of the precoder.

In certain embodiments, the set of combining coefficients comprises multiple subsets of combining coefficients, wherein each subset comprises combining coefficients that are associated with the same layer or a subset of layers of the precoder.

The rotation factor(s) of the DFT-based basis set(s) corresponding to the set of time and/or frequency-domain components associated with each subset of combining coefficients is/are either determined by the wireless device and reported, or configured to the wireless device, or fixed in the NR specifications and hence known to the wireless device. In some examples, the rotation factors are contained in the CSI report. In some examples, there are multiple rotation factors where some of them are reported by the wireless device and some of them are either configured to the wireless device, or they are fixed and known to the wireless device.

### Selection of Basis Vectors and Indication in CSI Report

In certain embodiments, the wireless device receives a CSI-report configuration from a network node, or gNB, or another wireless device. The wireless device is configured with a set of spatial-domain components (first basis set) and determines from the set of spatial-domain components a subset (i.e., one or more) of spatial-domain components for the precoder. The subset of spatial-domain components is smaller than the set of spatial-domain components.

The wireless device selects a number of basis vectors (e.g., L basis vectors) from the first basis set, wherein the first basis set corresponds to the set of spatial domain components, and the number of selected basis vectors is smaller than the number of basis vectors of the first basis set. The selected basis vectors are indicated in the CSI report. In some examples, the selected basis vectors are indicated by a bitmap or by a combinatorial bit indicator (e.g., by a

$$⌈ {log}_{2} ( \begin{matrix}{N}_{1} {N}_{2} \\ L\end{matrix} ) ⌉$$

bit indicator, or thereof).

In certain embodiments, the wireless device that is configured with a set of frequency-domain components (second basis set) determines a subset (i.e., one or more) of frequency-domain components from the set of frequency-domain components, wherein the subset of frequency-domain components is smaller than the set of frequency-domain components. The wireless device selects a number of basis vectors (i.e., M basis vectors) from the second basis set, wherein the number of selected basis vectors is smaller than the number of basis vectors of the second basis set. In certain embodiments, the selected M basis vectors (or delays) are indicated in the CSI report. In some examples, the selected basis vectors are indicated by a bitmap or a combinatorial bit indicator (e.g., a

$$⌈ {log}_{2} ( \begin{matrix}{N}_{3} \\ M\end{matrix} ) ⌉$$

or by a

$$⌈ {log}_{2} ( \begin{matrix}{N}_{3} - 1 \\ M - 1\end{matrix} ) ⌉$$

bit indicator).

In certain embodiments, the wireless device that is configured with a first set and a second set of frequency-domain components determines a number of basis vectors for each set associated with the frequency-domain components of the precoder, wherein the number of selected basis vectors is smaller than the number of basis vectors of each set of frequency-domain components. Note that, similar to above, the elements in the first set of frequency-domain components are different to the elements in the second set of frequency-domain components. The first set of frequency-domain components may comprise a number of basis vectors associated with a first resolution/rotation factor of the delays for the precoder vector or matrix, and the second set of frequency-domain components may comprise a number of basis vectors associated with a second resolution/rotation factor of the delays for the precoder vector or matrix. In some examples, the first resolution may be higher than the second resolution or identical (see above). In certain embodiments, the selected basis vectors from each set of frequency-domain components are indicated in the CSI report.

In certain embodiments, the wireless device that is configured with a set of time-domain components (third basis set) determines a subset of time-domain components from the set of time-domain components, wherein the subset of time-domain components is smaller than the set of time-domain components. The wireless device selects a number of basis vectors (i.e., N basis vectors) from the third basis set, wherein the number of selected basis vectors is smaller than the number of basis vectors of the third basis set. In certain embodiments, the selected N basis vectors (or Doppler frequencies) are indicated in the CSI report. In some examples, the selected basis vectors are indicated by a bitmap or a combinatorial bit indicator (e.g., a

$$⌈ {log}_{2} ( \begin{matrix}{N}_{4} \\ N\end{matrix} ) ⌉$$

or by a

$$⌈ {log}_{2} ( \begin{matrix}{N}_{4} - 1 \\ N - 1\end{matrix} ) ⌉$$

bit indicator).

In certain embodiments, the wireless device that is configured with a first set and a second set of time-domain components determines a number of basis vectors per set associated with the time-domain components of the precoder, wherein the number of selected basis vectors is smaller than the number of basis vectors of each set of time-domain components. Note that, similar to above, the elements in the first set of time-domain components are different to the elements in the second set of time-domain components. The first set of time-domain components may comprise a number of basis vectors associated with a first resolution/rotation factor of the Doppler frequencies for the precoder vector or matrix, and the second set of time-domain components may comprise a number of basis vectors associated with a second resolution/rotation factor of the Doppler frequencies for the precoder vector or matrix. The first resolution may be higher than the second resolution (see above) or identical. In certain embodiments, the selected basis vectors from each set of frequency-domain components are indicated in the CSI report.

In certain embodiments, the wireless device determines a spatial-domain-specific subset for each selected spatial-domain component, comprising one or more time-domain components selected from the selected time-domain components and one or more frequency-domain components from the selected frequency-domain components. The wireless device also determines a set of combining coefficients for combining the selected spatial-domain component(s), time-domain component(s) and frequency-domain component(s) from the spatial-domain-specific subsets. The wireless device generates and transmits, to a network node or other wireless device, a CSI report, the CSI report comprising an indication of the selected one or more spatial-domain components, an indication of the selected one or more time-domain components and an indication of the selected one or more frequency-domain components from the spatial-domain-specific subsets, and an indication of the combining coefficients of the precoder vector or matrix.

In certain embodiments, the set of spatial-domain components corresponding to the first basis set comprises O₁O₂N₁N₂ basis vectors, the set of frequency-domain components corresponding to the second basis set comprises N₃ or N₃O₃ basis vectors, and the set of time-domain components corresponding to the third basis set comprises N₄ or N₄O₄ basis vectors. The wireless device selects out of the O₁O₂N₁N₂ basis vectors, L basis vectors from the first basis set, wherein L<O₁O₂N₁N₂. The wireless device selects M out of N₃ or N₃O₃ basis vectors from the second basis set, wherein M<N₃ or M<N₃O₃. The wireless device selects N basis vectors out of N₄ or N₄O₄ basis vectors from the third basis set, wherein N<N₄ or N<N₄O₄.

In certain embodiments, the selected subsets of time- and frequency-domain component(s) (e.g., the M and N basis vectors selected from the second and third basis set, respectively) have a common basis for the selected spatial-domain components (e.g., the L selected basis vectors from the first basis vector set) of the precoder per transmission layer, or subset of transmission layers, or all transmission layers. The common basis (per transmission layer, or subset of transmission layers, or all transmission layers) is indicated in the CSI report. In some examples, the wireless device indicates the common basis by bitmap(s) or by combinatorial indicator(s) for the selected subsets of time-domain component(s) and selected subset of frequency-domain component(s) as explained above.

In certain embodiments, each oversampling factor mentioned above can be configured, or selected and reported by the UE, or is fixed in the NR specification and known by the wireless device (e.g., Oᵣ=1 . . . Xᵣ where Xᵣ is any positive integer value).

### Indication of Spatial/Time/Frequency Components in the CSI Report

In certain embodiments, the wireless device determines a spatial-domain-specific subset for each selected spatial-domain component from the subset of spatial-domain components, wherein the spatial-domain-specific subset comprises one or more time-domain components selected from the subset of time-domain components and one or more frequency-domain components selected from the subset of frequency-domain components. The one or more time-domain components and the one or more frequency-domain components of the spatial-domain-specific subset are indicated in the CSI report. In some examples, the wireless device determines a spatial-domain-specific subset for each selected basis vector from the first basis set, comprising M′ basis vectors from the M selected basis vectors (which represent the subset of frequency-domain components) of the second basis set, and N′ basis vectors from the N selected basis vectors (which represent the subset of time-domain components) of the third basis set, wherein M′≤M and N′≤N. The selected M′ basis vectors are a subset of the M selected basis vectors and are indicated in the CSI report. The selected N′ basis vectors are a subset of the N selected basis vectors and are indicated for each selected basis vector (i.e., each selected spatial-domain component) from the first basis set in the CSI report.

In certain embodiments, the M′ and N′ selected basis vectors from the second and third basis sets, respectively, are indicated via a bitmap for each selected spatial component in the CSI report. In another embodiment, the M′ and N′ selected basis vectors from the second and third basis sets, respectively, are indicated via combinatorial bit indicators for each selected spatial component in the CSI report. In some examples, the combinatorial bit indicator is given by a

$$⌈ {log}_{2} ( \begin{matrix}M \\ {M}^{′}\end{matrix} ) ⌉ or ⌈ {log}_{2} ( \begin{matrix}N \\ {N}^{′}\end{matrix} ) ⌉$$

bit indicator.

In certain embodiments, the selected one or more basis vectors from the first, second, and third basis sets of the precoder are indicated by a bitmap in the CSI report, wherein each bit is associated with selected basis vectors from the first, second, and third basis sets and a combining coefficient of the precoder. In certain embodiments, each selected frequency-, time- and spatial-component is associated with a non-zero combining coefficient of the precoder vector or matrix.

In certain embodiments, the selected one or more basis vectors from the first, second, and third basis sets of the precoder are indicated by a bitmap of length 2LMN in the CSI report, wherein each bit is associated with selected basis vectors from the first, second, and third basis sets.

In certain embodiments, the selected one or more basis vectors from the first, second, and third basis sets of the precoder are indicated by a bitmap of length 2LMN in the CSI report, wherein each bit is associated with selected basis vectors from the first, second, and third basis sets and a zero or non-zero combining coefficient of the precoder.

In certain embodiments, the UE is configured to select K_{NZ} non-zero combining coefficients across all selected spatial components and M′ and N′ selected basis vectors from the second and third basis sets for each selected spatial component.

In certain embodiments, the number of selected basis vectors from the second and third basis sets, i.e., M′ and N′, respectively, may be identical for a subset or all selected basis vectors from the first basis set.

In certain embodiments, the number of selected basis vectors from the second and third basis sets, i.e., M′ and N′, respectively, may be different for each selected basis vector from the first basis set.

In certain embodiments, the number of non-zero combining coefficients associated with a spatial-domain-specific subset of each selected basis vector from the first basis set is less than or equal M′ or N′ or M′N′ or M or N or M′N or MN′. As the wireless device determines a spatial-domain-specific subset for each selected spatial-domain component from the subset of spatial-domain components i.e., for each basis vector from the first basis set, the number of non-zero combining coefficients are dependent only on the selected M′ and N′ basis vectors from the second and third basis sets, respectively, instead of M and N basis vectors.

In certain embodiments, the wireless device is configured to report only a subset of the 2LMN length bitmap to reduce the feedback overhead.

In certain embodiments, the wireless device is configured to report a bitmap of size M′ or N′ or M′N′ or M or N or M′N or MN′ for each spatial-domain-specific subset of a selected basis vector from the first basis set. Each bit in the reduced size bitmap is associated with a zero or a non-zero combining coefficient.

In certain embodiments, the wireless device is configured to select K_{NZ} non-zero combining coefficients from a total of Σ_{∀l}Mₗ′ or Σ_{∀l}Nₗ′ or Σ_{∀l}Mₗ′Nₗ′ precoder coefficients, where, Mₗ′ and Nₗ′ are the number of basis vectors from the second and third basis sets of the spatial-domain-specific subset associated with the l-th spatial component or the l-th basis vector from the first basis set.

In certain embodiments, the wireless device is configured to report a subset of the bitmap, wherein the subset is associated with a specific region of the 2LMN length bitmap and wherein the specific region is determined by the UE with respect to a reference coefficient with index {lᵣ, fᵣ, nᵣ}, wherein lᵣ is the index of the basis vector from the first basis set, fᵣ is the index of the basis vector from the second basis set and nᵣ is the index of the basis vector from the third basis set.

In certain embodiments, the reference coefficient is given by the strongest combining coefficient or strongest coefficient.

In certain embodiments, the index of the reference coefficient associated with the basis vector from the second basis set is given by fᵣ=0.

In certain embodiments, the wireless device is configured to determine and report a subset of the 2LMN length bitmap, wherein the subset of the bitmap comprises the bits that satisfy the 0≤e(l, f, n)≤g, ∀l, f, n, wherein e(l, f, n)=min(abs(l−lᵣ), L−abs(l−lᵣ))+min(abs(f−fᵣ), M−abs(f−fr))+min(abs(n−nᵣ), N−abs(n−nᵣ)) and wherein lᵣ is the index of the basis vector from the first basis set associated with the reference coefficient, fᵣ is the index of the basis vector from the second basis set associated with the reference coefficient and nᵣ is the index of the basis vector from the third basis set associated with the reference coefficient and g is a parameter that takes any integer value greater than zero.

In certain embodiments, the wireless device is configured to determine and report a subset of the 2LMN length bitmap, wherein the subset of the bitmap comprises the bits that satisfy the 0≤e(l, f, n)≤g, ∀l, f, n, wherein e(l, f, n)=min(abs(l−lᵣ), L−abs(l−lᵣ))+min(abs(f), M−abs(f))+min(abs(n−nᵣ), N−abs(n−nᵣ)) and wherein lᵣ is the index of the basis vector from the first basis set associated with the reference coefficient, and nᵣ is the index of the basis vector from the third basis set associated with the reference coefficient and g is a parameter that takes any integer value greater than zero.

In certain embodiments, the wireless device is configured to determine and report a subset of the 2LMN length bitmap, wherein the subset of the bitmap comprises the bits that satisfy the e(l, f, n)≤g, ∀l, f, n, wherein e(l, f, n)=min(abs(l−lᵣ), L−abs(l−lᵣ))+min(abs(f−fᵣ), M−abs(f−fr))+min(abs(n−nᵣ), N−abs(n−nᵣ)) and wherein lᵣ is the index of the basis vector from the first basis set associated with the reference coefficient, fᵣ is the index of the basis vector from the second basis set associated with the reference coefficient and nᵣ is the index of the basis vector from the third basis set associated with the reference coefficient and g is a parameter that takes any integer value greater than zero.

In certain embodiments, the wireless device is configured to determine and report a subset of the 2LMN length bitmap, wherein the subset of the bitmap comprises the bits that satisfy the e(l, f, n)≤g, ∀l, f, n, wherein e(l, f, n)=min(abs(l−lᵣ), L−abs(l−lᵣ))+min(abs(f), M−abs(f))+min(abs(n−nᵣ), N−abs(n−nᵣ)) and wherein 1r is the index of the basis vector from the first basis set associated with the reference coefficient, and nᵣ is the index of the basis vector from the third basis set associated with the reference coefficient and g is a parameter that takes any integer value greater than zero.

In certain embodiments, the parameter g is either configured to the UE via RRC configuration or determined by the UE and reported in the CSI report or fixed or known to the UE.

In certain embodiments, the value of g is determined by the UE based on the configured values of L and M, wherein L and M are number of basis vectors from the first and second basis sets, respectively.

In certain embodiments, the value of g is determined by the UE based on the configured values of L and N, wherein L and N are number of basis vectors from the second and third basis sets, respectively.

In certain embodiments, the value of g is determined by the UE based on the configured values of L, wherein L is the number of basis vectors from the first basis set.

In certain embodiments, the value of g is determined by the UE based on the configured values of M, wherein M is the number of basis vectors from the second basis set.

In certain embodiments, the value of g is determined by the UE based on the configured values of M and N, wherein M and N are number of basis vectors from the second and third basis sets, respectively.

In certain embodiments, the value of g is determined by the UE based on the configured values of L, M and N, wherein L, M and N are number of basis vectors from the first, second and third basis sets, respectively.

In certain embodiments, the number of bits in the bitmap associated with each spatial-domain-specific subset may be different.

In certain embodiments, the wireless device is configured to report a bitmap comprising less than MN bits for each spatial-domain-specific subset associated with each selected basis vector from the first basis set. Each bit in the reduced size bitmap is associated with a zero or a non-zero combining coefficient.

In certain embodiments, the number of bits of the bitmap reported for the spatial-domain specific subset of a selected basis vector from the first basis set associated with a reference or strongest coefficient is identical for both polarizations.

In certain embodiments, each frequency- and time domain component of the spatial-domain specific subset is associated with a non-zero combining coefficient of the precoder vector or matrix.

In certain embodiments, the subset of time domain components is configured to the wireless device, e.g., from a network node, or gNB, or other wireless device.

In certain embodiments, the number of time domain components (e.g., the parameter N indicating the subset size) in a subset of time domain components is configured to the wireless device, e.g., from a network node, or gNB, or other wireless device.

In certain embodiments, the subset of frequency domain components is configured to the wireless device, e.g., from a network node, or gNB, or other wireless device.

In certain embodiments, the number of frequency domain components (e.g., the parameter M indicating the subset size) in a subset of frequency domain components is configured to the wireless device, e.g., from a network node, or gNB, or other wireless device.

In certain embodiments, the spatial-domain-specific subset for a selected spatial-domain component is identical over two polarizations, wherein the spatial-domain-specific subset comprises one or more time-domain components selected from the subset of time-domain components and one or more frequency-domain components selected from the subset of frequency-domain components. The one or more time-domain components and the one or more frequency-domain components of the spatial-domain-specific subset specific to both polarizations are indicated in the CSI report.

In certain embodiments, the spatial-domain-specific subset for a selected spatial-domain component is identical for a subset of layers, wherein the spatial-domain-specific subset comprises one or more time-domain components selected from the subset of time-domain components and one or more frequency-domain components selected from the subset of frequency-domain components. The one or more time-domain components and the one or more frequency-domain components of the spatial-domain-specific subset specific to a subset of layers are indicated in the CSI report.

In certain embodiments, the spatial-domain-specific subset for a selected spatial-domain component is identical over two polarizations and a subset of layers, wherein the spatial-domain-specific subset comprises one or more time-domain components selected from the subset of time-domain components and one or more frequency-domain components selected from the subset of frequency-domain components. The one or more time-domain components and the one or more frequency-domain components of the spatial-domain-specific subset specific to both polarizations and a subset of layers are indicated in the CSI report.

### Precoder Matrix

In certain embodiments, the precoder vector or matrix of a transmission layer and associated with the two polarizations of the antenna ports is given by

$${W}_{t , n} = \{ \begin{matrix}{\sum }_{l = 0}^{L - 1} {v}_{l} {\sum }_{f = 0}^{M - 1} {\sum }_{n = 0}^{F - 1} {c}_{l , f , n} {y}_{t , l}^{( f )} {x}_{h , l}^{( n )} , \\ {\sum }_{l = 0}^{L - 1} {v}_{l + L} {\sum }_{f = 0}^{M - 1} {\sum }_{n = 0}^{F - 1} {c}_{l + L , f , n} {y}_{t , l + L}^{( f )} {x}_{h , l + L}^{( n )} ,\end{matrix}$$

where,
vₗ denotes a basis vector selected from the first basis set (the set of spatial domain components) and corresponds to a spatial-domain component of the precoder,
c_{l,f,n} denotes the complex combining coefficient associated with the I-th selected spatial-domain component, f-th frequency-domain component, and n-th time-domain component of the precoder vector or matrix,

$${y}_{t , l}^{( f )} = {e}^{\sqrt{- 1} \frac{2 π {tn}_{3 , l}^{( f )}}{{N}_{3}}} or {y}_{t , l}^{( f )} = {e}^{- \sqrt{- 1} \frac{2 π {tn}_{3 , l}^{( f )}}{{N}_{3}}}$$

is the t-h (t=0,1, . . . , N₃−1) component/entry of the n_{3,l}^{(f)}-th basis vector/frequency-domain component selected from the second basis set associated with the frequency-domain components of the precoder, and

$${x}_{h , l}^{( n )} = {e}^{\sqrt{- 1} \frac{2 π {hn}_{4 , l}^{( n )}}{{N}_{4}}} or {x}_{h , l}^{( n )} = {e}^{- \sqrt{- 1} \frac{2 π {hn}_{4 , l}^{( n )}}{{N}_{4}}}$$

is the h-th (h=0,1, . . . , N₄−1) component/entry of the n_{4,l}⁽ⁿ⁾-th basis vector/time-domain component selected from the third basis set associated with the time-domain components of the precoder.

In some examples, W_{t,n} is replaced by W_{t,h}, where t=0,1, . . . , N₃−1 and h=0,1, . . . , N₄−1 and wherein N₃ and N₄ are the number of subbands or PRBs or frequency units and number of time instances or slots, respectively.

In accordance with embodiments, the precoder vector or matrix of a transmission layer associated with the two polarizations of the antenna ports is normalized such that the power of the precoder vector or matrix for each subband or PRBs or frequency units and time instance or slot is equal to one.

In accordance with embodiments, the precoder vector or matrix of each transmission layer associated with the two polarizations of the antenna ports is normalized such that the total sum power of the precoder vector or matrix for each subband or PRBs or frequency units and time instance or slot across all RI transmission layers is equal to one.

In accordance with embodiments, the precoder vector or matrix of each transmission layer associated with the two polarizations of the antenna ports is normalized such that the total sum power of the precoder vector or matrix for each subband or PRBs or frequency units across all N₄ time instances or slots and RI layers is equal to one.

In accordance with embodiments, the precoder vector or matrix of RI transmission layers associated with the two polarizations of the antenna ports is normalized such that the sum power of the precoder vector or matrix per transmission layer is given by 1/RI.

### Selection of Basis Vectors for Time and Frequency Domain Components of the Precoder

In certain embodiments, the basis set corresponding to the set of time-domain components (third basis set) is an oversampled DFT- or DCT-based matrix comprising O₄ orthogonal DFT- or DCT-based matrices.

In certain embodiments, the wireless device selects a single orthogonal DFT- or DCT-based matrix from the oversampled DFT- or DCT-based matrix and selects one or more basis vectors (per transmission layer or subset of transmission layers or all transmission layers) representing the time domain components of the precoder from the selected orthogonal DFT- or DCT-based matrix. In some examples, the selected orthogonal DFT- or DCT-based matrix is indicated in the CSI report (by reporting the rotation factor q₄ indicating the selected orthogonal DFT- or DCT-based matrix from the oversampled DFT- or DCT-based matrix).

In certain embodiments, the wireless device determines for a subset of combining/combination coefficients an orthogonal DFT- or DCT-based matrix from an oversampled DFT- or DCT-based matrix representing the time domain or frequency domain components of the precoder. The wireless device determines one or more basis vectors from the orthogonal DFT- or DCT-based matrix. In some examples, the selected or determined orthogonal DFT- or DCT-based matrix is indicated in the CSI report. For example, the rotation factor q₃ or q₄ indicating the selected orthogonal DFT- or DCT-based matrix from the oversampled DFT- or DCT-based matrix is indicated in the CSI report. In some examples, the subset of combining coefficients is associated with one or more selected spatial components of a layer or set of layers or all layers of the precoder. In another example, the subset of combining coefficients is associated with a single selected spatial component and the two polarizations of the precoder. In another example, the subset of combining or combination coefficients is associated with a single selected spatial component and a single polarization of the precoder. In another example, the subset of combining coefficients comprises all combining coefficients of the precoder (per layer or subset of layers, or all layers). In some examples, the subset of combining coefficients comprises only a single combining coefficient. In such a case, the wireless device determines for each combining coefficient an orthogonal DFT- or DCT-based matrix from an oversampled DFT- or DCT-based matrix representing the time domain or frequency domain components of the precoder.

In certain embodiments, the wireless device selects or determines one or more spatial-, frequency-, and time-domain components from the set of spatial-, frequency-, and time-domain components for each subset of combining coefficients, wherein each combining coefficient from the subset of combining coefficient is associated with one spatial-, frequency-, and time-domain component selected from the sets of spatial-, frequency-, and time-domain components. Note that the wireless device can select or determine multiple subset of combining coefficients for the precoder.

In a sub-embodiment, all combining coefficients of the subset of combining coefficients are associated with the same spatial-domain component. This means the spatial-domain component is identical for the combining coefficients from the subset of combining coefficients.

Similarly, in a sub-embodiment, all combining coefficients of the subset of combining coefficients are associated with the same time-domain component. This means the time domain component is identical for the combining coefficients from the subset of combining coefficients.

In a further sub-embodiment, all combining coefficients of the subset of combining coefficients are associated with the same frequency-domain component. This means the frequency-domain component is identical for the combining coefficients from the subset of combining coefficients.

In a further sub-embodiment, all combining coefficients of the subset of combining coefficients are associated with the same spatial-domain and time-domain component. This means the spatial-domain component and time domain component are identical for the combining coefficients from the subset of combining coefficients.

In a further sub-embodiment, all combining coefficients of the subset of combining coefficients are associated with the same spatial-domain component and frequency-domain component. This means the spatial-domain component and frequency-domain component are identical for the combining coefficients from the subset of combining coefficients.

In a further sub-embodiment, all combining coefficients of the subset of combining coefficients are associated with the same spatial-domain component, frequency-domain component, and time-domain component. This means the spatial-domain component, time domain component and frequency-domain component are identical for the combining coefficients from the subset of combining coefficients.

### Combining or Combination Coefficients Subsets

In certain embodiments, the wireless device determines for a first subset of combining coefficients an orthogonal DFT- or DCT-based matrix from an oversampled DFT- or DCT-based matrix representing the time domain or frequency domain components of the precoder. The wireless device determines for a second subset of combining coefficients one or more basis vectors from an orthogonal (non-oversampled or selected from an oversampled basis set with different factor/rotation factor compared to the DFT- or DCT-based matrix associated with the first subset of combining coefficients) DFT- or DCT-based matrix representing the time domain or frequency domain components of the precoder. The wireless device also determines one or more basis vectors from the orthogonal DFT- or DCT-based matrix determined from the oversampled DFT- or DCT-based matrix. In some examples, the selected orthogonal DFT- or DCT-based matrices are indicated in the CSI report. In some examples, the two subsets of combining coefficients are associated with one or more selected spatial components for a layer or set of layers or all layers of the precoder. In another example, the two subsets of combining coefficients are associated with the single selected spatial component and the two polarizations of the precoder. In another example, the two subsets of combining coefficients are associated with the same selected spatial component and a single polarization of the precoder.

In certain embodiments, the wireless device determines for a first subset of combining coefficients an orthogonal DFT- or DCT-based matrix from an oversampled DFT- or DCT-based matrix representing the time domain components of the precoder and an orthogonal DFT- or DCT-based matrix from an oversampled DFT- or DCT-based matrix representing the frequency domain components of the precoder. The wireless device determines one or more basis vectors from each orthogonal DFT- or DCT-based matrix. In some examples, the selected orthogonal DFT- or DCT-based matrices are indicated in the CSI report. The wireless device determines for a second subset of combining coefficients one or more basis vectors from an orthogonal (non-oversampled or selected from an oversampled basis set with different factor/rotation factor compared to the DFT- or DCT-based matrix associated with the first subset of combining coefficients) DFT- or DCT-based matrix representing the time domain components of the precoder and one or more basis vectors from an orthogonal (non-oversampled or selected from an oversampled basis set with different factor/rotation factor compared to the DFT- or DCT-based matrix associated with the first subset of combining coefficients) DFT- or DCT-based matrix representing the frequency domain components of the precoder. In some examples, the two subsets of combining coefficients are associated with one or more selected spatial components for a layer or set of layers or all layers of the precoder. In another example, the two subsets of combining coefficients are associated with the single selected spatial component and the two polarizations of the precoder. In another example, the two subsets of combining coefficients are associated with the same selected spatial component and a single polarization of the precoder.

### Indication of Strongest Combining or Combination Coefficient

In certain embodiments, the wireless device is configured to determine a strongest combining coefficient from the set of combining coefficients of the precoder across all layers or per layer or subset of layers and to normalize the combining coefficients such that the strongest coefficient is given the value 1. In certain embodiments, the strongest coefficient is not reported (or contained in the set of combining coefficients), but indicated via a strong coefficient indicator, SCI, in the CSI report.

In certain embodiments, the wireless device is configured to indicate the strongest combination coefficient for each spatial domain component, or for a subset of spatial-domain components for each layer or subset of layers in the CSI report.

### Combining or Combination Coefficient Quantization

In accordance with embodiments, the combining coefficients γ (without index for simplicity) indicated in the CSI report are quantized and is represented by one of the following schemes:

(1) γ=\hat{γ}ϕ, with
\hat{γ} is an amplitude coefficient which is quantized with N bits; and
ϕ=exp (−j2πc) represents a phase which is represented by a BPSK, QPSK, 8PSK, 16PSK, or any higher-order constellation, or

(2) γ=Re{γ}+jImag{γ}, with
Re{γ} and Imag{γ} represent the real and imaginary part of γ, and are quantized with Nᵣ and Nᵢ bits, respectively, or

(3) γ=a, where
a represents a real-valued amplitude, selected from {0,1}, or

(4) γ=abφ, where
a represents a real-valued differential amplitude, quantized with Nₐ bits, and
b represents a common amplitude over a subset of combining coefficients (e.g., subset of combining coefficients with respect to a single spatial-domain component for each polarization per layer or across a subset of layers or a single spatial-domain component across two polarizations per layer or across a subset of layers, or a subset of spatial-domain components per polarization per layer or across a subset of layers or a subset of spatial-domain components across both polarizations per layer or across a subset of layers, and/or a single frequency-domain component per polarization per layer or across a subset of layers or a single frequency-domain component across two polarizations per layer or across a subset of layers, or a subset of frequency-domain components for each polarization per layer or across a subset of layers or a subset of frequency-domain components across two polarizations per layer or across a subset of layers, and/or a single time-domain component per polarization per layer or across a subset of layers or a single time-domain component across two polarizations per layer or across a subset of layers, or a subset of time-domain components for each polarization per layer or across a subset of layers or a subset of time-domain components across two polarizations per layer or across a subset of layers), quantized with N_{b} bits,
φ=exp (−j2πc) is a phase which is represented by a BPSK, QPSK, 8PSK, 16PSK, or any higher-order constellation.

In a first example, γ=abφ, and b represents a common amplitude over a subset of combining coefficients associated with respect to a single spatial-domain component for each polarization per layer or across a subset of layers.

In a second example, γ=abφ, and b represents a common amplitude over a subset of combining coefficients associated with respect to a single spatial-domain component across both polarizations per layer or across a subset of layers.

In a third example, γ=abφ, and b represents a common amplitude over a subset of combining coefficients associated with respect to a subset of spatial-domain components for each polarization per layer or across a subset of layers.

In a fourth example, γ=abφ, and b represents a common amplitude over a subset of combining coefficients associated with respect to a subset of spatial-domain components across both polarization per layer or across a subset of layers.

In a fifth example, γ=abφ, and b represents a common amplitude over a subset of combining coefficients associated with respect to a single frequency/time-domain component for each polarization per layer or across a subset of layers.

In a sixth example, γ=abφ, and b represents a common amplitude over a subset of combining coefficients associated with respect to a single frequency/time-domain component across both polarization per layer and/or across a subset of layers.

In a seventh example, γ=abφ, and b represents a common amplitude over a subset of combining coefficients associated with respect to a subset of frequency/time-domain components for each polarization per layer or across a subset of layers.

In a eighth example, γ=abφ, and b represents a common amplitude over a subset of combining coefficients associated with respect to a subset of frequency/time-domain components across both polarization per layer or across a subset of layers.

In the following, some embodiments related to the determination and reporting of the common amplitude b are described.

According to an embodiment, b represents a common amplitude for a subset of combining coefficients, wherein the subset of combining coefficients comprises all combining coefficients associated with L spatial-domain components of a single polarization, M frequency-domain components, and N time-domain components.

According to an embodiment, b represents a common amplitude for a subset of combining coefficients, wherein the subset of combining coefficients comprises all combining coefficients associated with L spatial-domain components of a single polarization, M frequency-domain components, and a subset of time-domain components. The subset of time-domain components comprises less than N time-domain components.

According to an embodiment, b represents a common amplitude for a subset of combining coefficients, wherein the subset of combining coefficients comprises all combining coefficients associated with L spatial-domain components of a single polarization, a subset of frequency-domain components, and N time-domain components. The subset of frequency-domain components comprises less than M frequency-domain components.

According to an embodiment, b represents a common amplitude for a subset of combining coefficients, wherein the subset of combining coefficients comprises all combining coefficients associated with L spatial-domain components of a single polarization, a subset of frequency-domain components, and a subset of time-domain components. The subset of frequency-domain components comprises less than M frequency-domain components and the subset of time-domain components comprises less than N time-domain components.

According to an embodiment, b represents a common amplitude for a subset of combining coefficients, wherein the subset of combining coefficients comprises all combining coefficients associated with a subset of spatial-domain components of a single polarization, M frequency-domain components, and a subset of time-domain components. The subset of spatial-domain components comprises less than L spatial-domain components and the subset of time-domain components comprises less than N time-domain components.

According to an embodiment, b represents a common amplitude for a subset of combining coefficients, wherein the subset of combining coefficients comprises all combining coefficients associated with a subset of spatial-domain components of a single polarization, a subset of frequency-domain components, and N time-domain components. The subset of spatial-domain components comprises less than L spatial-domain components and the subset of frequency-domain components comprises less than M frequency-domain components.

According to an embodiment, b represents a common amplitude for a subset of combining coefficients, wherein the subset of combining coefficients comprises all combining coefficients associated with a subset of spatial-domain components of a single polarization, a subset of frequency-domain components, and a subset of time-domain components. The subset of spatial-domain components comprises less than L spatial-domain components, the subset of frequency-domain components comprises less than M frequency-domain components, and the subset of time-domain components comprises less than N time-domain components.

According to an embodiment, b represents a common amplitude for a subset of combining coefficients, wherein the subset of combining coefficients comprises all combining coefficients associated with 2L spatial-domain components of both polarizations, M frequency-domain components, and a subset of time-domain components. The subset of time-domain components comprises less than N time-domain components.

According to an embodiment, b represents a common amplitude for a subset of combining coefficients, wherein the 2L spatial-domain components of both polarizations, a subset of frequency-domain components, and N time-domain components. The subset of frequency-domain components comprises less than M frequency-domain components.

According to an embodiment, b represents a common amplitude for a subset of combining coefficients, wherein the subset of combining coefficients comprises all combining coefficients associated with 2L spatial-domain components of both polarizations, a subset of frequency-domain components, and a subset of time-domain components. The subset of frequency-domain components comprises less than M frequency-domain components and the subset of time-domain components comprises less than N time-domain components.

According to an embodiment, b represents a common amplitude for a subset of combining coefficients, wherein the subset of combining coefficients comprises all combining coefficients associated with a subset of spatial-domain components common across both polarizations, M frequency-domain components, and a subset of time-domain components. The subset of spatial-domain components comprises less than L spatial-domain components and the subset of time-domain components comprises less than N time-domain components.

According to an embodiment, b represents a common amplitude for a subset of combining coefficients, wherein the subset of combining coefficients comprises all combining coefficients associated with a subset of spatial-domain components common across both polarizations, a subset of frequency-domain components, and N time-domain components. The subset of spatial-domain components comprises less than L spatial-domain components and the subset of frequency-domain components comprises less than M frequency-domain components.

According to an embodiment, b represents a common amplitude for a subset of combining coefficients, wherein the subset of combining coefficients comprises all combining coefficients associated with a subset of spatial-domain components common across both polarizations, a subset of frequency-domain components, and a subset of time-domain components. The subset of spatial-domain components comprises less than L spatial-domain components, the subset of frequency-domain components comprises less than M frequency-domain components, and the subset of time-domain components comprises less than N time-domain components.

In some options, for each subset of combining coefficients per layer, a single common amplitude b is determined and reported per layer. In another option, for each subset of the combining coefficients for a subset of a layers (e.g., layer 0 and layer 1), a single common amplitude b is determined and reported. In some examples, for a single subset of combining coefficients, b=1, and not reported. The single subset of combining coefficients comprises the strongest combining coefficient across all combining coefficients. When the combining coefficients are normalized, the strongest combining coefficient is given by the value of 1.

In the following, some embodiments related to the subsets of time-domain components are described.

According to an embodiment, the wireless device is configured to determine the number of subsets for the time-domain components from the number, N, of time-domain components or the number of time-domain component subsets is known to the wireless device or fixed in the 3GPP specifications. In another option, the number of subsets for the time-domain components is configured from a network node, or gNB. Each time-domain component subset comprises N or less than N time-domain components.

In some examples, there are two time-domain component subsets and N time-domain components, and the number of time-domain components in the first subset is 1 and comprises the first time-domain component and the number of time-domain components in the second subset is N−1 and comprises the remaining N−1 time-domain components. In some options, the N time-domain components are sorted in an increasing order.

In some examples, there are two time-domain component subsets and N time-domain components, the number of time-domain components in the first subset is ┌N/2┐ and comprises the first ┌N/2┐ time-domain components, and the number of time-domain components in the second subset is └N/2┘ and comprises the remaining └N/2┘ time-domain components. In one option, the N time-domain components are sorted in an increasing order.

In the following, some embodiments related to the subsets of frequency-domain components are described.

According to an embodiment, the wireless device is configured to determine the number of subsets from the frequency-domain components from the number, M, of frequency-domain components or the number of frequency-domain component subsets is known to the wireless device or fixed in the 3GPP specifications. In another embodiment, the number of subsets from the frequency-domain components is configured from a network node, or gNB. Each frequency-domain component subset comprises M or less than M frequency-domain components.

In some examples, there are two frequency-domain component subsets and M frequency-domain components, and the number of frequency-domain components in the first subset is 1 and comprises the first frequency-domain component and the number of frequency-domain components in the second subset is M−1 and comprises the remaining M−1 time-domain components. In one option, the M time-domain components are sorted in an increasing order.

In some examples, there are two frequency-domain component subsets and M frequency-domain components, the number of frequency-domain components in the first subset is ┌M/2┐ and comprises the first ┌M/2┐ frequency-domain components, and the number of frequency-domain components in the second subset is └M/2┘ and comprises the remaining └M/2┘ frequency-domain components. In some options, the M frequency-domain components are sorted in an increasing order.

In some embodiments, the number of subsets of the combining coefficients, S, is configured to the UE by the network node, or gNB, or determined by the UE or fixed in the specification.

In some examples, the number of subsets of combining coefficients S is equal to two. In some examples, the number of subsets of the combining coefficients, S is equal to four.

In the following, some embodiments related to the number of bits used the quantization of the differential amplitude and common amplitude are described.

In some embodiments, the number of bits, Nₐ, used for the quantization of the differential amplitude is identical for the S subsets of combining coefficients.

In some embodiments, the number of bits, Nₐ, used for the quantization of the differential amplitude is different for each subset of combining coefficients.

In some embodiments, the number of bits, Nₐ, used for the quantization of the differential amplitude is identical only for a subset (e.g., subset 0 and subset 1) among all subsets of combining coefficients. In some examples, the number of combining coefficient subsets is 4 and the number of bits, Nₐ₁, used for quantizing the differential amplitudes is identical for the combining coefficients in subsets 0 and 1, and the number of bits, Nₐ₂, used for quantizing the differential amplitudes is identical for the combining coefficients in subsets 2 and 3, and Nₐ₁is different to Na₂.

In some embodiments, the number of bits, N_{b}, used for the quantization of the common amplitude is identical for S subsets of the combining coefficients.

In some embodiments, the number of bits, N_{b}, used for the quantization of the common amplitude is different for each subset of combining coefficients.

In some embodiments, the number of bits, N_{b}, used for the quantization of the common amplitude is identical only for a subset (e.g., subset 0 and subset 1) among all subsets of combining coefficients. In some examples, the number of combining coefficient subsets is 4 and the number of bits, N_{b1}, used for quantizing the common amplitudes is identical for the combining coefficients in subsets 0 and 1, and the number of bits, N_{b2}, used for quantizing the common amplitudes is identical for the combining coefficients in subsets 2 and 3, and N_{b}i is different to N_{b2}.

In accordance with embodiments, the wireless device is configured to quantize the differential amplitudes with Nₐ=3 bits using the quantization levels

$$\{ 0 , \sqrt{1 / 64} , \sqrt{1 / 32} , \sqrt{1 / 16} , \sqrt{1 / 8} , \sqrt{1 / 4} , \sqrt{1 / 2} , 1 \} .$$

In accordance with embodiments, the wireless device is configured to quantize the differential amplitudes with Nₐ=3 bits using the quantization levels

$$\{ \sqrt{1 / 128} , \sqrt{1 / 64} , \sqrt{1 / 32} , \sqrt{1 / 16} , \sqrt{1 / 8} , \sqrt{1 / 4} , \sqrt{1 / 2} , 1 \} .$$

In accordance with embodiments, the wireless device is configured to quantize the differential amplitudes with Nₐ=2 bits using the quantization levels {0,0.25,0.5,1}.

In accordance with embodiments, the wireless device is configured to quantize the differential amplitudes with Nₐ=2 bits using the quantization levels

$$\{ \sqrt{1 / 16} , \sqrt{1 / 16} , \sqrt{1 / 14} , 1 \} .$$

In accordance with embodiments, the wireless device is configured to quantize the differential amplitudes with N_{b}=4 bits using the quantization levels

$$\{ \frac{1}{\sqrt{128}} , {( \frac{1}{8192} )}^{\frac{1}{4}} , \frac{1}{8} , {( \frac{1}{2048} )}^{\frac{1}{4}} , \frac{1}{2 \sqrt{8}} , {( \frac{1}{512} )}^{\frac{1}{4}} , \frac{1}{4} , {( \frac{1}{128} )}^{\frac{1}{4}} , \frac{1}{\sqrt{8}} , {( \frac{1}{32} )}^{\frac{1}{4}} , \frac{1}{2} , {( \frac{1}{8} )}^{\frac{1}{4}} , \frac{1}{\sqrt{2}} , {( \frac{1}{2} )}^{\frac{1}{4}} , 1 \} .$$

In accordance with embodiments, the wireless device is configured to quantize the differential amplitudes with N_{b}=4 bits using the quantization levels

$$\{ x , \frac{1}{\sqrt{128}} , {( \frac{1}{8192} )}^{\frac{1}{4}} , \frac{1}{8} , {( \frac{1}{2048} )}^{\frac{1}{4}} , \frac{1}{2 \sqrt{8}} , {( \frac{1}{512} )}^{\frac{1}{4}} , \frac{1}{4} , {( \frac{1}{128} )}^{\frac{1}{4}} , \frac{1}{\sqrt{8}} , {( \frac{1}{32} )}^{\frac{1}{4}} , \frac{1}{2} , {( \frac{1}{8} )}^{\frac{1}{4}} , \frac{1}{\sqrt{2}} , {( \frac{1}{2} )}^{\frac{1}{4}} , 1 \} ,$$

where x can be a value between

$$\frac{1}{\sqrt{128}} and {( \frac{1}{8192} )}^{\frac{1}{4}} .$$

In accordance with embodiments, the wireless device is configured to quantize the differential amplitudes with N_{b}=4 bits using the quantization levels

$$\{ x , \frac{1}{\sqrt{128}} , {( \frac{1}{8192} )}^{\frac{1}{4}} , \frac{1}{8} , {( \frac{1}{2048} )}^{\frac{1}{4}} , \frac{1}{2 \sqrt{8}} , {( \frac{1}{512} )}^{\frac{1}{4}} , \frac{1}{4} , {( \frac{1}{128} )}^{\frac{1}{4}} , \frac{1}{\sqrt{8}} , {( \frac{1}{32} )}^{\frac{1}{4}} , \frac{1}{2} , {( \frac{1}{8} )}^{\frac{1}{4}} , \frac{1}{\sqrt{2}} , {( \frac{1}{2} )}^{\frac{1}{4}} , 1 \} ,$$

where x can be a value between

$$\frac{1}{\sqrt{128}} and \frac{1}{\sqrt{256}} .$$

(5) γ=abcφ, where
a represents a real-valued differential amplitude, quantized with Nₐ bits, and
b represents a common amplitude over a subset of combining coefficients (e.g., subset of combining coefficients with respect to a single spatial-domain component for each polarization per layer or across a subset of layers or a single spatial-domain component across two polarizations per layer or across a subset of layers, or a subset of spatial-domain components per polarization per layer or across a subset of layers or a subset of spatial-domain components across both polarizations per layer or across a subset of layers), quantized with N_{b} bits,
c represents a second common amplitude over a subset of combining coefficients (e.g., subset of combining coefficients with respect to a single frequency-domain component per polarization per layer or across a subset of layers or a single frequency-domain component across two polarizations per layer or across a subset of layers, or a subset of frequency-domain components for each polarization per layer or across a subset of layers or a subset of frequency-domain components across two polarizations per layer or across a subset of layers and/or a single time-domain component per polarization per layer or across a subset of layers or a single time-domain component across two polarizations per layer or across a subset of layers, or a subset of time-domain components for each polarization per layer or across a subset of layers or a subset of time-domain components across two polarizations per layer or across a subset of layers), quantized with N_{c} bits,
φ=exp (−j2πc) is a phase which is represented by a BPSK, QPSK, 8PSK, 16PSK, or any higher-order constellation.

In a first example, γ=abcφ, and b represents a common amplitude over a subset of combining coefficients associated with respect to a single spatial-domain component for each polarization per layer or across a subset of layers.

In a second example, γ=abcφ, and b represents a common amplitude over a subset of combining coefficients associated with respect to a single spatial-domain component across both polarizations per layer or across a subset of layers.

In a third example, γ=abcφ, and b represents a common amplitude over a subset of combining coefficients associated with respect to a subset of spatial-domain components for each polarization per layer or across a subset of layers.

In a fourth example, γ=abcφ, and b represents a common amplitude over a subset of combining coefficients associated with respect to a subset of spatial-domain components across both polarization per layer or across a subset of layers.

In a fifth example, γ=abcφ, and c represents a common amplitude over a subset of combining coefficients associated with respect to a single frequency/time-domain component for each polarization per layer or across a subset of layers.

In a sixth example, γ=abcφ, and c represents a common amplitude over a subset of combining coefficients associated with respect to a single frequency/time-domain component across both polarization per layer or across a subset of layers.

In a seventh example, γ=abcφ, and c represents a common amplitude over a subset of combining coefficients associated with respect to a subset of frequency/time-domain components for each polarization per layer or across a subset of layers.

In a eighth example, γ=abcφ, and c represents a common amplitude over a subset of combining coefficients associated with respect to a subset of frequency/time-domain components across both polarization per layer or across a subset of layers.

(6) γ=abcdφ, where
a represents a real-valued differential amplitude, quantized with Nₐ bits, and
b represents a common amplitude over a subset of combining coefficients (e.g., subset of combining coefficients with respect to a single spatial-domain component for each polarization per layer or across a subset of layers or a single spatial-domain component across two polarizations per layer or across a subset of layers, or a subset of spatial-domain components per polarization per layer or across a subset of layers or a subset of spatial-domain components across both polarizations per layer or across a subset of layers), quantized with N_{b} bits,
c represents a second common amplitude over a subset of combining coefficients (e.g., subset of combining coefficients with respect to a single frequency-domain component per polarization per layer or across a subset of layers or a single frequency-domain component across two polarizations per layer or across a subset of layers, or a subset of frequency-domain components for each polarization per layer or across a subset of layers or a subset of frequency-domain components across two polarizations per layer or across a subset of layers), quantized with N_{c} bits,
d represents a third common amplitude over a subset of combining coefficients (e.g., subset of combining coefficients with respect to a single time-domain component per polarization per layer or across a subset of layers or a single time-domain component across two polarizations per layer or across a subset of layers, or a subset of time-domain components for each polarization per layer or across a subset of layers or a subset of time-domain components across two polarizations per layer or across a subset of layers), quantized with N_{d} bits, and
φ=exp (−j2πc) is a phase which is represented by a BPSK, QPSK, 8PSK, 16PSK, or any higher-order constellation.

In a first example, γ=abcdφ, and b represents a common amplitude over a subset of combining coefficients associated with respect to a single spatial-domain component for each polarization per layer or across a subset of layers.

In a second example, γ=abcdφ, and b represents a common amplitude over a subset of combining coefficients associated with respect to a single spatial-domain component across both polarizations per layer or across a subset of layers.

In a third example, γ=abcdφ, and b represents a common amplitude over a subset of combining coefficients associated with respect to a subset of spatial-domain components for each polarization per layer or across a subset of layers.

In a fourth example, γ=abcdφ, and b represents a common amplitude over a subset of combining coefficients associated with respect to a subset of spatial-domain components across both polarization per layer or across a subset of layers.

In a fifth example, γ=abcdφ, and c represents a common amplitude over a subset of combining coefficients associated with respect to a single frequency-domain component for each polarization per layer or across a subset of layers.

In a sixth example, γ=abcdφ, and c represents a common amplitude over a subset of combining coefficients associated with respect to a single frequency-domain component across both polarization per layer or across a subset of layers.

In a seventh example, γ=abcdφ, and c represents a common amplitude over a subset of combining coefficients associated with respect to a subset of frequency-domain components for each polarization per layer or across a subset of layers.

In an eighth example, γ=abcdφ, and c represents a common amplitude over a subset of combining coefficients associated with respect to a subset of frequency-domain components across both polarization per layer or across a subset of layers.

In a ninth example, γ=abcdφ, and d represents a common amplitude over a subset of combining coefficients associated with respect to a single time-domain component for each polarization per layer or across a subset of layers.

In a tenth example, γ=abcdcφ, and d represents a common amplitude over a subset of combining coefficients associated with respect to a single time-domain component across both polarization per layer or across a subset of layers.

In an eleventh example, γ=abcdcφ, and d represents a common amplitude over a subset of combining coefficients associated with respect to a subset of time-domain components for each polarization per layer or across a subset of layers.

In a twelfth example, γ=abcdcφ, and d represents a common amplitude over a subset of combining coefficients associated with respect to a subset of time-domain components across both polarization per layer or across a subset of layers.

### Codebook Subset Restriction

In certain embodiments, the selected spatial-domain components selected by the wireless device may be aligned with the multipath structure of the radio channel. Some of the spatial-domain vectors selected by the wireless device can cause significant interference to other wireless devices within the same cell (multi-user/intra-cell interference) or to other wireless devices in neighboring cells (inter-cell interference). To reduce multi-user interference and inter-cell interference, the UE may be configured per layer with a subset of spatial-domain components (i.e., basis vectors from the first basis set), where for the configured or indicated spatial-domain vectors the average amplitude or power of the combining or combination coefficients associated with the indicated spatial-domain component is restricted. In some examples, the restricted spatial-domain components are indicated by higher layer (RRC) by the network node, or another wireless device, or they are known at the wireless device, or selected by the device and reported as a part of the CSI report by the wireless device to the network node. The wireless device can be configured with a maximum allowed amplitude value for each indicated restricted spatial-domain component. The maximum amplitude value may restrict the amplitude values of the combining or combination coefficients associated with the indicated spatial-domain component. In one example, the maximum amplitude value w_{z} for the z-th basis vector associated with a restricted spatial-domain component vector may restrict the common amplitude value a_{l,p,i} of the combining coefficients γ_{p,i,d}^{(l)}, such that a_{l,p,i}≤w_{z} In another instance, the maximum amplitude value w_{z} for the z-th restricted spatial-domain vector may restrict the amplitudes |γ_{p,i,d}^{(l)}| of the combining coefficients γ_{p,i,d}^{(l)}, such that

$$\vert {γ}_{p , i , d}^{( l )} \vert \leq {w}_{z} , ∀ d .$$

In another instance, the maximum amplitude value w_{z} for the z-th restricted spatial-domain vector may restrict the average power

$$\sqrt{{\sum }_{d} {\vert {γ}_{p , i , d}^{( l )} \vert}^{2}}$$

of the combining coefficients γ_{p,i,d}^{(l)}, such that

$$\sqrt{{\sum }_{d} {\vert {γ}_{p , i , d}^{( l )} \vert}^{2}} \leq {w}_{z} .$$

The maximum amplitude value may restrict the amplitude values of the combining or combination coefficients associated with the indicated spatial-domain component. In one example, the maximum amplitude value wᵣ for the r-th basis vector associated with a restricted spatial-domain component vector may restrict the common amplitude value a_{l,f,n} of the combining coefficient γ_{l,f,n} such that a_{l,f,n}≤wᵣ. In another instance, the maximum amplitude value w_{z} for the z-th restricted spatial-domain vector may restrict the amplitudes |γ_{l,f,n}| of the combining coefficients γ_{l,f,n}, such that |γ_{l,f,n}|≤w_{z}, ∀f, n. In another instance, the maximum amplitude value wᵣ for the r-th restricted spatial-domain vector may restrict the average power

$$\sqrt{{\sum }_{f , n} {\vert {γ}_{l , f , n} \vert}^{2}}$$

of the combining coefficients γ_{l,f,n}, such that

$$\sqrt{{\sum }_{f , n} {\vert {γ}_{l , f , n} \vert}^{2}} \leq {w}_{r} .$$

In accordance with some exemplary embodiments, the restricted spatial-domain components or vectors are indicated by a bitmap B together with the maximum average amplitude values for each spatial-domain component or vector.

The network node may indicate to the wireless device the spatial-domain components in a subset of spatial-domain components and a maximum allowable average amplitude values per spatial-domain component by the B bitmap.

In accordance with some exemplary embodiments, the bitmap B may be comprised of two parts, B=B₁B₂, where a first bitmap part B₁ may indicate G spatial-domain component groups (g=1, . . . , G), where each spatial-domain component group may comprise R spatial-domain components or vectors. In one instance, the number of spatial-domain components or vectors is R=N₁N₂, so that in each of the G spatial-domain groups there are N₁N₂ spatial-domain components or vectors and there is a total of GN₁N₂ restricted spatial-domain components or vectors. The second bitmap part B₂ may be defined by a RN_{B}-length bit sequence

$${B}_{2} = {b}_{2}^{( g , R - 1 )} , … , {b}_{2}^{( g , 0 )} , r = 0 , … , R - 1 ,$$

where b₂^{(g,r)}=b_{2,0}^{(g,r)}, . . . , b_{2,N}_{_{B}}₋₁^{(g,r)} is a bit sequence of length N_{B} indicating the maximum allowed amplitude value w_{g,r} for the r-th spatial-domain vector in the g-th spatial-domain group. In one instance, N_{B}=2 and the maximum amplitude values are defined by the mapping in Table 1.

TABLE 1
Mapping of bits b_{2,0}^{(g,r)}, b_{2,1}^{(g,r)} to maximum amplitude
coefficient for N_{B} = 2.

| Bits b_{2,0}^{(g,z)}, b_{2,1}^{(g,z)} or | Maximum amplitude |
|---|---|
| Bits b_{2,0}^{(g,r)}, b_{2,1}^{(g,r)} | coefficient w_{g,r} |
| 00 | 0 |
| 01 | $\sqrt{1 / 4}$ |
| 10 | $\sqrt{1 / 2}$ |
| 11 | 1 |

In another instance, N_{B}=1 and the maximum amplitude values are defined by the mapping in Table 2 or the mapping in Table 3.

TABLE 2
Mapping of b_{2,0}^{(g,r)} to maximum amplitude coefficient for N_{B} = 1.

| Bit b_{2,0}^{(g,r)} | Maximum amplitude value w_{g,r} |
|---|---|
| 0 | 0 |
| 1 | $\sqrt{1 / 2}$ |

TABLE 3
Mapping of bit b_{2, 0}^{(g, r)} to maximum
amplitude coefficient for N_{B} = 1.

| Bit b_{2, 0}^{(g, r)} | Maximum amplitude value w_{g, r} |
|---|---|
| 0 | 0 |
| 1 | 1 |

In accordance with some exemplary embodiments, each of the G spatial-domain component groups indicated by the bitmap B₁ may be comprised of N₁N₂ orthogonal DFT spatial-domain vectors or components selected from the first basis set, where the indices of the spatial-domain vectors of the g-th beam group or of the g-th spatial-domain component group are defined by the index set:

$$I ( {r}_{1}^{( g )} , {r}_{2}^{( g )} ) = \{ ( {r}_{1}^{( g )} {N}_{1} + {x}_{1} , {r}_{2}^{( g )} + {N}_{2} + {x}_{2} ) : {x}_{1} = 0 , 1 , … , {N}_{1} - 1 , {x}_{2} = 0 , 1 , … , {N}_{2} - 1 \} ,$$

where f=O_{1,1}r₂^{(g)}+r₁^{(g)} for r₁^{(g)}∈{0, . . . , O_{1,1}−1}, r₂^{(g)}∈{0, . . . , O_{1,2}−1} denotes the spatial-domain group index indicated by the bitmap B₁. The corresponding DFT-based spatial-domain vectors v_{l,m} with (l, m)∈I(r₁^{(g)} r₂^{(g)}) in the g-th spatial-domain group are then defined by

$$\begin{matrix}{v}_{l , m} = {[ \begin{matrix}{u}_{m} & exp ( j \frac{2 π l}{{O}_{1 , 1} {N}_{2}} ) {u}_{m} & … & exp ( j \frac{2 π l ( {N}_{1} - 1 )}{{O}_{1 , 1} {N}_{1}} )\end{matrix} {u}_{m} ]}^{T} , \\ {u}_{m} = {[ \begin{matrix}1 & exp ( j \frac{2 π m}{{O}_{1 , 2} {N}_{2}} ) & … & exp ( j \frac{2 π m ( {N}_{2} - 1 )}{{O}_{1 , 1} {N}_{2}} )\end{matrix} ]}^{T} for {N}_{2} > 1 , and \\ {u}_{m} = 1 for {N}_{2} = 1 .\end{matrix}$$

In accordance with some exemplary embodiments, the bitmap B may be signaled from the gNB to the UE via higher layer (RRC).

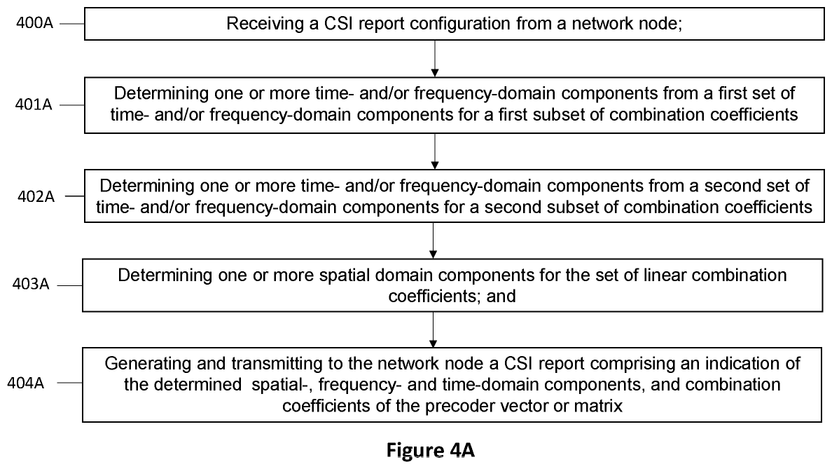

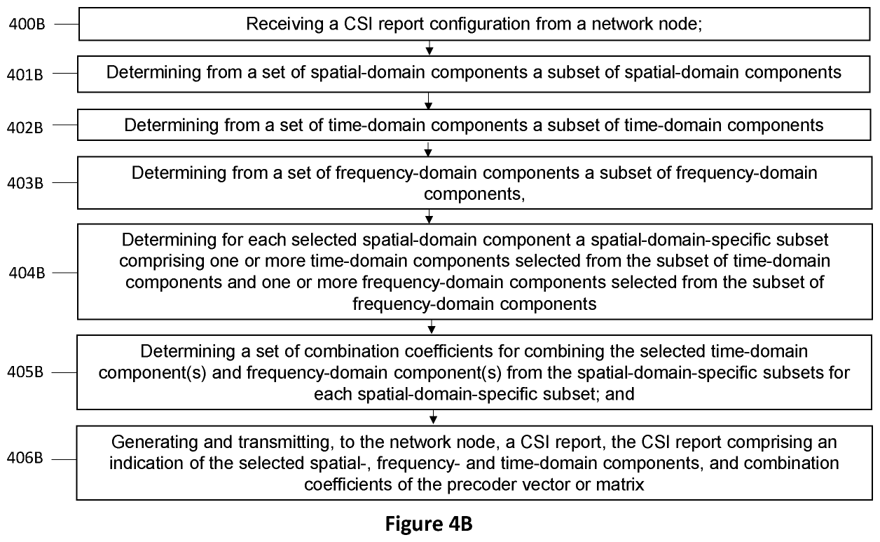

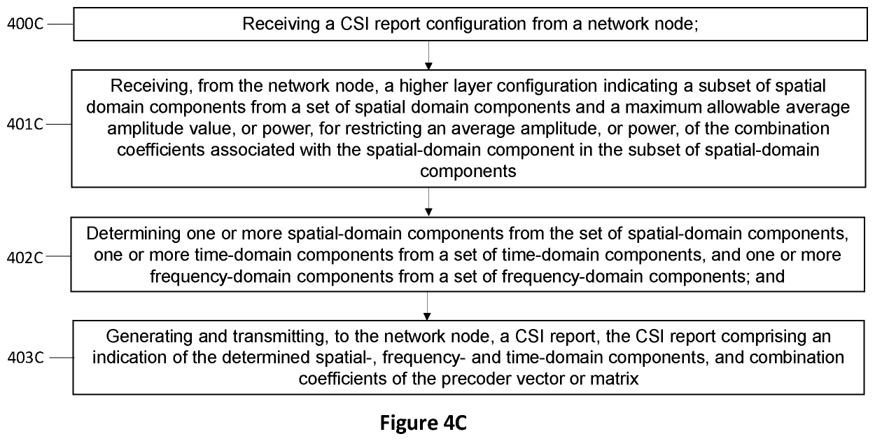

Referring to FIG. 4A, there is illustrated a method performed by a wireless device according to some of the previously described embodiments. The method is performed by the wireless device (or UE) for generating and transmitting a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components. As shown, the method comprising:
receiving (400A) a CSI report configuration from a network node;
determining (401A) one or more time- and/or frequency-domain components from a first set of time- and/or frequency-domain components for a first subset of combination coefficients,
determining (402A) one or more time- and/or frequency-domain components from a second set of time- and/or frequency-domain components for a second subset of combination coefficients,
determining (403A) one or more spatial domain components for the set of linear combination coefficients, and;
generating and transmitting or reporting (404A), to the network node (or gNB), a CSI report, the CSI report comprising an indication of the determined or selected spatial-, frequency- and time-domain components, and combining coefficients of the precoder vector or matrix.

According to an embodiment, the set of combining coefficients comprises at least two or multiple subsets of combining coefficients, wherein for each subset of combining or combination coefficients the wireless device determines one or more time- and/or frequency-domain components from a set of time- and/or frequency-domain components specific to the subset of combining or combination coefficients.

According to an embodiment, the time- and/or frequency-domain components from each set are time-domain components, frequency-domain components, or time- and frequency-domain components.

According to an embodiment, the first and second set of time- and/or frequency-domain components comprises a first and second set of frequency-domain components and a first and second set of time-domain components.

According to an embodiment, the first set and the second set of frequency-domain components or time-domain components are associated with different basis vector sets.

According to an embodiment, each basis vector of the basis vector set of the time-domain components is associated with a Doppler frequency and the Doppler frequencies associated with the basis vectors in a first and a second sets have different resolutions.

According to an embodiment, each vector of the basis vector set of the frequency-domain components is associated with a delay and delays associated with the basis vectors in the first and the second sets have different resolutions.

According to an embodiment, a first basis vector set of the frequency domain components is an oversampled DFT-based basis set, or a rotated DFT-based basis set and a second set basis vector set of the frequency domain components is a non-oversampled DFT-based basis set.

According to an embodiment, a first and a second basis vector sets are rotated DFT-based basis sets with identical or different rotation factors. The rotation factor of a basis vector set is selected by the wireless device and reported, or configured to wireless device, or fixed and known to the wireless device.

Referring to FIG. 4B, there is illustrated another method performed by a wireless device according to some of the previously described embodiments. The method is performed by the wireless device for generating and transmitting a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components. As shown, the method comprising:
receiving (400B) a CSI report configuration from a network node;
determining (401B) from a set of spatial-domain components a subset of spatial-domain components,
determining (402B) from a set of time-domain components a subset of time-domain components,
determining (403B) from a set of frequency-domain components a subset of frequency-domain components,
determining (404B) for each selected spatial-domain component from the subset of spatial-domain components a spatial-domain-specific subset comprising one or more time-domain components selected from the subset of time-domain components and one or more frequency-domain components selected from the subset of frequency-domain components,
determining (405B) a set of combining or combination coefficients for combining the selected time-domain component(s) and frequency-domain component(s) from the spatial-domain-specific subsets for each spatial-domain-specific subset, and
generating and transmitting or reporting (406B), to the network node, a CSI report, the CSI report comprising an indication of the selected spatial-, frequency- and time-domain components, and combining or combination coefficients of the precoder vector or matrix.

According to an embodiment, the set of time-domain, spatial-domain or frequency-domain components is a basis set represented by a DFT-based or a DCT-based matrix or an oversampled DFT-based or DCT-based matrix or a rotated DFT-based or DCT-based matrix.

Referring to FIG. 4C, there is illustrated yet another method performed by a wireless device according to some of the previously described embodiments. The method is performed by the wireless device for generating and transmitting or reporting a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components. As shown, the method comprising:
receiving (4000) a CSI report configuration from a network node;
receiving (401C), from the network node, a higher layer configuration comprising indicating a subset of spatial domain components from a set of spatial domain components and a maximum allowable average amplitude value, or power, for restricting an average amplitude, or power, of the combining or combination coefficients associated with the spatial-domain component in the subset of spatial-domain components;
determining (402C) one or more spatial-domain components from the set of spatial-domain components, one or more time-domain components from a set of time-domain components, and one or more frequency-domain components from a set of frequency-domain components, and
generating and transmitting or reporting (403), to the network node, a CSI report, the CSI report comprising an indication of the determined or selected spatial-, frequency- and time-domain components, and combining or combination coefficients of the precoder vector or matrix.

According to an embodiment, the maximum allowable average amplitude value of the combining or combination coefficients associated with the spatial-domain component in the subset of spatial-domain components restricts the average amplitude, or average power of the combining or combination coefficients of the spatial domain component across two polarizations.

According to an embodiment, and as previously described, the method further comprises indicating spatial-domain components in a subset of spatial-domain components and a maximum allowable average amplitude value per spatial-domain component by a bitmap B, wherein the bitmap B comprises two parts, a first bitmap part 1 and a second bitmap part B₂, wherein B=B₁B₂ and wherein the first bitmap part B₁ indicates G beam groups (g=1, . . . , G), where each beam group comprises R spatial-domain components.

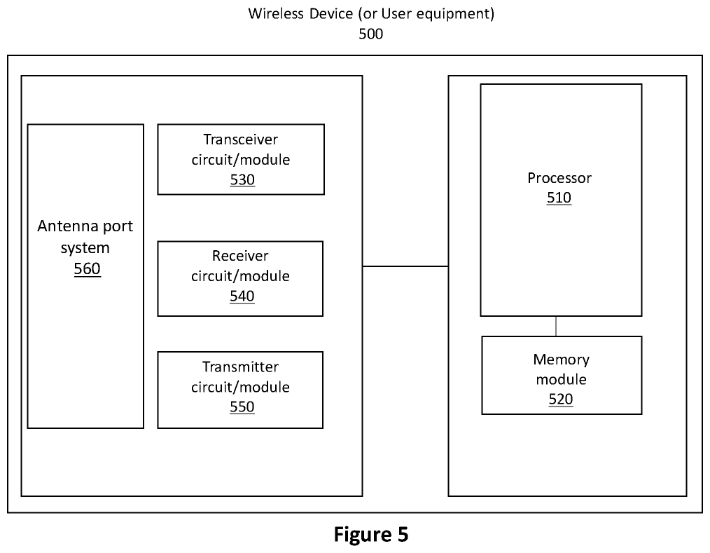

In order to perform the previously described process or method steps performed by the wireless or UE there is also provided a wireless device. FIG. 5 illustrates a block diagram depicting a wireless device or UE 500. The wireless device 500 comprises a processor 510 or processing circuit or a processing module or a processor means 510; a receiver circuit or receiver module 540; a transmitter circuit or transmitter module 550; a memory module 520, a transceiver circuit or transceiver module 530 which may include the transmitter circuit 550 and the receiver circuit 540. The wireless device 500 further comprises an antenna system 560 which includes antenna circuitry for transmitting and receiving signals to/from at least the network node or other wireless device(s). The antenna system employs beamforming as previously described.

The wireless device 500 may belong to any radio access technology including 4G or LTE, LTE-A, 5G, advanced 5G or a combination thereof that support beamforming technology. The wireless device comprising the processor and the memory contains instructions executable by the processor, whereby the wireless device 500 is operative or is configured to perform any one of the embodiments related to the wireless device as previously described.

The processing module/circuit 510 includes a processor, microprocessor, an application specific integrated circuit (ASIC), field programmable gate array (FPGA), or the like, and may be referred to as the “processor.” The processor 510 controls the operation of the wireless device and its components. Memory (circuit or module) 520 includes a random-access memory (RAM), a read only memory (ROM), and/or another type of memory to store data and instructions that may be used by processor 510. In general, it will be understood that the wireless device 500 in one or more embodiments includes fixed or programmed circuitry that is configured to carry out the operations in any of the embodiments disclosed herein.

In at least one such example, the processor 510 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 500 may comprise additional components.

The wireless device 500 by means of processor 510 executes instructions contained in the memory 520 whereby the wireless device is operative to perform any one of the previously described embodiments related to the actions performed by the wireless device, some of which are presented in this disclosure.

There is also provided a computer program comprising instructions which when executed by the processor 510 of the wireless device cause the processor 510 to carry out the method according to the present disclosure.

There is also provided a method performed by a network node for receiving a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
transmitting, to a wireless device, a CSI report configuration; and
receiving, from the wireless device, a CSI report, the CSI report comprising an indication of selected or determined spatial-, frequency- and time-domain components, and combining or combination coefficients of the precoder vector or matrix; wherein the content of the CSI report is determined by the wireless device according to claim 10.

The actions performed by the wireless device for determining the CSI report for transmission to the network node were previously presented and need not be repeated.

There is also provided another method performed by a network node for receiving a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
transmitting, to a wireless device, a CSI report configuration; and
receiving, from a wireless device, a CSI report, the CSI report comprising an indication of selected or determined spatial-, frequency- and time-domain components, and combining coefficients of the precoder vector or matrix; wherein the content of the CSI report is determined by the wireless device according to claim 15.

There is also provided yet another method performed by a network node for receiving a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
transmitting, to a wireless device, a CSI report configuration;
transmitting, to the wireless device, a higher layer configuration indicating a subset of spatial domain components from a set of spatial domain components and a maximum allowable average amplitude value, or power, for restricting an average amplitude, or power, of the combining coefficients associated with the spatial-domain component in the subset of spatial-domain components; and
receiving, from the wireless device, a CSI report, the CSI report comprising an indication of selected or determined spatial-, frequency- and time-domain components, and combining coefficients of the precoder vector or matrix; wherein the content of the CSI report is determined by the wireless device according to claim 1. The actions performed by the wireless device for determining the CSI report for transmission to the network node were previously presented and need not be repeated.

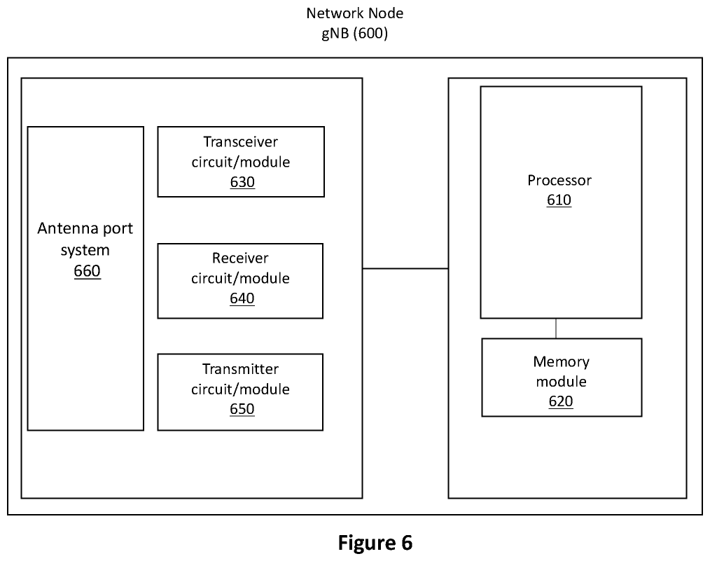

In order to perform the previously described process or method steps performed by the network node there is also provided a network node. FIG. 6 illustrates a block diagram depicting a network node 600. The network node 600 comprises a processor 610 or processing circuit or a processing module or a processor means 610; a receiver circuit or receiver module 640; a transmitter circuit or transmitter module 650; a memory module 620, a transceiver circuit or transceiver module 630 which may include the transmitter circuit 650 and the receiver circuit 640. The network node 600 further comprises an antenna system 660 which includes antenna circuitry for transmitting and receiving signals to/from at least the wireless device. The antenna system employs beamforming as previously described.

The network node 600 may belong to any radio access technology including 4G or LTE, LTE-A, 5G, advanced 5G or a combination thereof that support beamforming technology. The network device comprising the processor and the memory contains instructions executable by the processor, whereby the network node 600 is operative or is configured to perform any one of the embodiments related to the network node 600 as previously described.

The processing module/circuit 610 includes a processor, microprocessor, an application specific integrated circuit (ASIC), field programmable gate array (FPGA), or the like, and may be referred to as the “processor.” The processor 610 controls the operation of the network node and its components. Memory (circuit or module) 620 includes a random-access memory (RAM), a read only memory (ROM), and/or another type of memory to store data and instructions that may be used by processor 610. In general, it will be understood that the network node in one or more embodiments includes fixed or programmed circuitry that is configured to carry out the operations in any of the embodiments disclosed herein.

In at least one such example, the processor 610 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 600 may comprise additional components. The network node 600 may also be viewed as a Transmitter and Receiver Point (TRP).

The network node 600 by means of processor 610 executes instructions contained in the memory 620 whereby the network node 600 is operative to perform any one of the previously described embodiments related to the actions performed by the network node, some of which are presented in the present disclosure.

There is also provided a computer program comprising instructions which when executed by the processor 610 of the network node cause the processor 610 to carry out the method according to the present disclosure.

Several advantages of the described embodiments in this disclosure are achieved as previously described and which include significantly reducing the feedback overhead and the computational complexity at the wireless device for codebook-based CSI reporting. Another advantage is to reduce latency in the CSI reporting.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. The embodiments herein may be applied in any wireless systems including LTE or 4G, LTE-A (or LTE-Advanced), 5G, advanced 5G, WiMAX, WiFi, satellite communications, TV broadcasting etc.

1-26. (canceled)

27. A method performed by a wireless device for generating and reporting or transmitting a channel state information (CSI) report in a wireless communication system, the CSI report indicating a plurality of precoder vectors or matrices, a precoder vector or matrix of the plurality of precoder vectors or matrices being expressed as a linear combination of spatial-domain component(s), frequency-domain component(s) and time-domain component(s), and a set of linear combination coefficients for combining the spatial-, frequency- and time-domain components, the method comprising:
receiving a CSI report configuration from a network node;
receiving, from the network node, a higher layer configuration indicating a subset of spatial-domain components from a set of spatial-domain components and a maximum average amplitude value, or a maximum average power, for restricting an average amplitude, or an average power, of the combination coefficients associated with the spatial-domain component in the subset of spatial-domain components;
determining one or more spatial-domain components from a set of spatial-domain components, one or more time-domain components from a set of time-domain components, and one or more frequency-domain components from a set of frequency-domain components; and
generating and transmitting or reporting, to the network node, the CSI report, the CSI report comprising an indication of the determined spatial-, frequency- and time-domain components, and the set of linear combination coefficients of the precoder vector or matrix.

28. The method according to claim 27, wherein the maximum average amplitude value of the combination coefficients associated with the spatial-domain component in the subset of spatial-domain components restricts the average amplitude, or the average power of the combination coefficients of the spatial-domain components across two polarizations.

29. The method according to claim 27, further comprising indicating the spatial-domain components in the subset of spatial-domain components and the maximum average amplitude value per spatial-domain component by a bitmap B, wherein the bitmap B comprises two parts, a first bitmap part B₁ and a second bitmap part B₂, wherein B=B₁B₂, and wherein the first bitmap part B₁ indicates G spatial-domain component groups (g=1, . . . , G), where each spatial-domain component group comprises R spatial-domain components.

30. The method according to claim 29, wherein the second bitmap part B₂ is defined by a RN_{B}-length bit sequence B₂=b₂^{(g,R-1)}, . . . , b₂^{(g,0)}, r=0, . . . , R−1, where b₂^{(g,r)}=b_{2,0}^{(g,r)}, . . . , b_{2,N}_{_{B}}₋₁^{(g,r)} is a bit sequence of length N_{B} indicating the maximum amplitude value w_{g,r} for the r-th spatial-domain vector in the g-th spatial-domain group.

31. The method according to claim 30, wherein a mapping of bits b_{2,0}^{(g,r)}, b_{2,1}^{(g,r)} to a maximum average amplitude value for N_{B}=2 is given by:

| Bits b_{2,0}^{(g,r)}, | |
|---|---|
| b_{2,1}^{(g,r)} | Maximum average amplitude value w_{g,r} |
| 00 | 0 |
| 01 | $\sqrt{1 / 4}$ |
| 10 | $\sqrt{1 / 2}$ |
| 11 | 1 |

32. The method according to claim 30, wherein a mapping of bits b_{2,0}^{(g,r)}, b_{2,1}^{(g,r)} to a maximum average amplitude value for N_{B}=1 is given by:

| Bit b_{2, 0}^{(g, r)} | Maximum average amplitude value w_{g, r} |
|---|---|
| 0 | 0 |
| 1 | 1 |

33. The method according to claim 27, wherein each combining coefficient, denoted γ, indicated in the CSI report is quantized and is represented by γ=abφ, where, a represents a real-valued differential amplitude quantized with Nₐ bits, and b represents a common amplitude over a subset of combining coefficients associated with a subset of spatial-domain components for each polarization per layer, quantized with N_{b} bits, and φ=exp(−j2πc) is a phase which is represented by a BPSK, QPSK, 8PSK, 16PSK, or any higher-order constellation.

34. The method according to claim 33, comprising: quantizing the differential amplitudes with Nₐ=3 bits using the quantization levels
$$\{ 0 , \sqrt{1 / 64} , \sqrt{1 / 32} , \sqrt{1 / 16} , \sqrt{1 / 8} , \sqrt{1 / 4} , \sqrt{1 / 2} , 1 \} .$$

35. The method according to claim 33, comprising: quantizing the common amplitude with N_{b}=4 bits using the quantization levels
$$\{ \frac{1}{\sqrt{128}} , {( \frac{1}{8192} )}^{\frac{1}{4}} , \frac{1}{8} , {( \frac{1}{2048} )}^{\frac{1}{4}} , \frac{1}{2 \sqrt{8}} , {( \frac{1}{512} )}^{\frac{1}{4}} , \frac{1}{4} , {( \frac{1}{128} )}^{\frac{1}{4}} , \frac{1}{\sqrt{8}} , {( \frac{1}{32} )}^{\frac{1}{4}} , \frac{1}{2} , {( \frac{1}{8} )}^{\frac{1}{4}} , \frac{1}{\sqrt{2}} , {( \frac{1}{2} )}^{\frac{1}{4}} , 1 \} .$$

36. A wireless device for generating and reporting or transmitting a channel state information (CSI) report in a wireless communication system, the CSI report indicating a plurality of precoder vectors or matrices, a precoder vector or matrix of the plurality of precoder vectors or matrices being expressed as a linear combination of spatial-domain component(s), frequency-domain component(s) and time-domain component(s), and a set of linear combination coefficients for combining the spatial-, frequency- and time-domain components, the wireless device comprising a processor and a memory containing instructions executable by said processor, whereby the wireless device is operative to:
receive a CSI report configuration from a network node;
receive, from the network node, a higher layer configuration indicating a subset of spatial-domain components from a set of spatial-domain components and a maximum average amplitude value, or a maximum average power, for restricting an average amplitude, or an average power, of the combination coefficients associated with the spatial-domain component in the subset of spatial-domain components;
determine one or more spatial-domain components from a set of spatial-domain components, one or more time-domain components from a set of time-domain components, and one or more frequency-domain components from a set of frequency-domain components; and
generate and transmit or report, to the network node, the CSI report, the CSI report comprising an indication of the determined spatial-, frequency- and time-domain components, and the set of linear combination coefficients of the precoder vector or matrix.

37. A method performed by a network node for receiving a channel state information (CSI) report in a wireless communication system, the CSI report indicating a plurality of precoder vectors or matrices, a precoder vector or matrix of the plurality of precoder vectors or matrices being expressed as a linear combination of spatial-domain component(s), frequency-domain component(s) and time-domain component(s), and a set of linear combination coefficients for combining the spatial-, frequency- and time-domain components, the method comprising:
transmitting, to a wireless device, a CSI report configuration;
transmitting, to the wireless device, a higher layer configuration indicating a subset of spatial-domain components from a set of spatial-domain components and a maximum average amplitude value, or a maximum average power, for restricting an average amplitude, or an average power, of the combination coefficients associated with the spatial-domain component in the subset of spatial-domain components; and
receiving, from the wireless device, the CSI report, the CSI report comprising an indication of determined spatial-, frequency- and time-domain components, and combination coefficients of the precoder vector or matrix; wherein the determined spatial-, frequency- and time-domain components are based on one or more spatial-domain components from a set spatial-domain components, one or more time-domain components from a set of time-domain components, and one or more frequency-domain components from a set of frequency-domain components.

38. A network node for receiving a channel state information (CSI) report in a wireless communication system, the CSI report indicating a plurality of precoder vectors or matrices, a precoder vector or matrix of the plurality of precoder vectors or matrices being expressed as a linear combination of spatial-domain component(s), frequency-domain component(s) and time-domain component(s), and a set of linear combination coefficients for combining the spatial-, frequency- and time-domain components, the network node comprising a processor and a memory containing instructions executable by said processor, whereby the network node is operative to:
transmit, to a wireless device, a CSI report configuration;
transmit, to the wireless device, a higher layer configuration indicating a subset of spatial-domain components from a set of spatial-domain components and a maximum average amplitude value, or a maximum average power, for restricting an average amplitude, or an average power, of the combination coefficients associated with the spatial-domain component in the subset of spatial-domain components; and
receive, from the wireless device, the CSI report, the CSI report comprising an indication of determined spatial-, frequency- and time-domain components, and combination coefficients of the precoder vector or matrix; wherein the determined spatial-, frequency- and time-domain components are based on one or more spatial-domain components from a set spatial-domain components, one or more time-domain components from a set of time-domain components, and one or more frequency-domain components from a set of frequency-domain components.
